(19) United States
(12) Patent Application Publication
(10) Pub. No.: US 2007/0058892 A1
(43) Pub. Date: Mar. 15, 2007

(54) Sensor-equipped rolling bearing assembly

(75) Inventors: Nobutsuna Motohashi, Katsuragi-shi (JP); Hirochika Ueyama, Hirakata-shi (JP); Yasukata Miyagawa, Habikino-shi (JP); Kenichi Kouduki, Kashiwara-shi (JP); Manabu Taniguchi, Kashihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JTEKT CORPORATION, Osaka-shi (JP)

(21) Appl. No.: 11/519,031

(22) Filed: Sep. 12, 2006

(30) Foreign Application Priority Data
Nov. 7, 2005 (JP) 2005-322651
Sep. 14, 2005 (JP) 2005-266481

(51) Int. Cl. F16C 41/04

(52) U.S. Cl. 384/448

(57) ABSTRACT

A sensor-equipped rolling bearing assembly includes: a cylindrical fixed bearing ring fixed to a vehicle body; a rotary bearing ring rotatably inserted through the fixed bearing ring and having a wheel-mounting portion on an outboard side thereof; and plural rows of rolling elements rollably interposed between these bearing rings. The bearing assembly is provided with a case member having plural displacement sensors which are circumferentially arranged at predetermined space intervals and which detect gaps between themselves and an outside surface of an inboard end of the rotary bearing ring. The case member is mounted to the inboard end of the fixed bearing ring.

### BACKGROUND OF THE INVENTION

The present invention relates to a sensor-equipped rolling bearing assembly used for rotatably supporting a wheel of a vehicle such as an automotive vehicle.

Modern automotive vehicles require a variety of information pieces for providing operation control while the vehicles are moving, the information pieces including, for example, load acting on the road wheel, the number of revolutions thereof. For acquisition of such information pieces, a proposal has been made to mount a sensor to a rolling bearing assembly to which the wheel of the vehicle is mounted.

The conventionally known sensor-equipped rolling bearing assemblies include a bearing assembly which includes: a cylindrical fixed bearing ring fixed to a vehicle body; a rotary bearing ring which is disposed radially inwardly of the fixed bearing ring and to which the wheel is mounted; and plural rows of rolling elements rollably interposed between these bearing rings. This bearing assembly has the sensor mounted to the fixed bearing ring such as to acquire information on the rotary bearing ring (see, for example, Japanese Unexamined Patent Publication No.2002-340922).

In the bearing assembly of the above patent publication, the fixed bearing ring is formed with a through-hole radially extending therethrough. The sensor is fixedly inserted in the through-hole. The sensor has its measurement portion confronting an outside surface of the rotary bearing ring, so as to acquire the information on the rotary bearing ring.

In the sensor-equipped rolling bearing assembly disclosed in Japanese Unexamined Patent Publication No.2002-340922, a plural number of through-holes must be formed in the fixed bearing ring in order to mount a plural number of sensors to the fixed bearing ring. In this case, the manufacture of the fixed bearing ring requires an additional step of forming the through-holes. In addition, it is required to mount each of the sensors in each of the through-holes. This results in a complicated assembly work. What is more, each of the sensors requires adjustment of gap defined between the sensor and the rotary bearing ring. This results in an increased number of assembly steps.

### SUMMARY OF THE INVENTION

In view of the foregoing, the invention has been accomplished and has an object to provide a sensor-equipped rolling bearing assembly which allows for the omission of the positional adjustment of the respective sensors mounted therein and hence, is easy to assemble.

Another object of the invention is to provide a sensor-equipped rolling bearing assembly which is adapted to determine a moment load and an axial translation load on the wheel by using only a sensor for detecting physical quantity varying in conjunction with the displacement of a peripheral surface of the rotary bearing ring. That is, the bearing assembly is also applicable to a driving wheel, thus achieving high generality.

According to a first aspect of the invention, a sensor-equipped rolling bearing assembly comprises: a cylindrical fixed bearing ring fixed to a vehicle body; a rotary bearing ring rotatably inserted through the fixed bearing ring and possessing a wheel-mounting portion on an outboard side thereof; and plural rows of rolling elements rollably interposed between these bearing rings, and is provided with a case member having a plurality of displacement sensors which are circumferentially arranged at predetermined space intervals and which detect gaps between themselves and an outside surface of an inboard end of the rotary bearing ring, the case member being mounted to the inboard end of the fixed bearing ring.

This constitution negates the need for discretely mounting the displacement sensors to the inboard end of the fixed bearing ring or the need for forming the sensor mounting through-holes in the fixed bearing ring, because the case member possesses the plural displacement sensors and is mounted to the inboard end of the fixed bearing ring. Furthermore, the bearing assembly is easy to assemble because the individual displacement sensors are positioned relative to the outside surface of the inboard end of the rotary bearing ring by mounting the case member to the fixed bearing ring.

The displacement sensor is capable of detecting the variations of the gap between itself and the outside surface of the inboard end of the rotary bearing ring, the gap variations being caused by a radial load applied to the wheel. In a case where the rotary bearing ring is so displaced as to incline relative to the fixed bearing ring (is subjected to a moment), the gap is varied more at the inboard end of the rotary bearing ring than at an axially central portion thereof. Therefore, the displacement sensor can achieve higher detection accuracy by taking measurement on the outside surface of the inboard end.

The displacement sensor may preferably be an inductance-type displacement sensor. Since the inductance-type displacement sensor is less susceptible to the earth magnetism, a constitution less susceptible to the earth magnetism can be embodied by mounting the bearing assembly equipped with this sensor to the vehicle such as the automotive vehicle which may move in any directions.

It is preferred that the case member further has a second displacement sensor for detecting a gap between itself and an axial-end face of the inboard end of the rotary bearing ring. In this case, the second displacement sensor can detect the variations of a gap between itself and the axial-end face of the inboard end of the rotary bearing ring, the gap variations being caused by an axial load on the wheel.

It is preferred in the above sensor-equipped rolling bearing assembly that the outside surface of the inboard end of the rotary bearing ring is so configured as to produce radial and axial variations of the gap between the outside surface and the displacement sensors when the load is applied to the rotary bearing ring. In this case, the displacement sensors circumferentially mounted to the case member are capable of detecting the radial and axial gap variations.

The rotary bearing ring may be formed with an annular recess in the outside surface of the inboard end thereof confronted by the plural displacement sensors. In this constitution, the axial displacement of the rotary bearing ring can be detected by the displacement sensors disposed circumferentially of the case member.

In a case where the displacement sensor is of the inductance type or of an eddy-current type, the rotary bearing ring may be formed with an annular band on the outside surface of the inboard end thereof confronted by the plural displacement sensors, the annular band being formed from a different material from that of the rotary bearing ring. In this case, as well, the axial displacement of the rotary bearing ring can be detected by the displacement sensors disposed circumferentially of the case member.

In the case where the displacement sensor is of the inductance type, it is preferred that an annular measurement subject member, which produces a greater inductance variation in the displacement sensors than the rotary bearing ring does, is mounted to the inboard end of the rotary bearing ring, wherein the displacement sensors detect gaps between themselves and an outside surface of the measurement subject member. This results in increased accuracies of the detection by the displacement sensors.

In the bearing assembly equipped with these sensors, the displacement sensors may preferably be connected to an arithmetic processor for calculating the respective direction components of the load applied to the rotary bearing ring by way of calculation using respective output values from the displacement sensors and a predetermined function previously stored in the processor. This makes it possible to calculate the load on the rotary bearing ring based on the output values from the displacement sensors. The predetermined function may be obtained by previously determining the values outputted from the respective displacement sensors in response to the input of the respective direction components of the load.

According to a second aspect of the invention, a sensor-equipped rolling bearing assembly comprises: a fixed bearing ring having a portion fixed to a vehicle body; a rotary bearing ring disposed coaxially with the fixed bearing ring and having a wheel-mounting portion; plural rows of rolling elements rollably interposed between these bearing rings for permitting these bearing rings to rotate relative to each other; and a sensor device disposed on the fixed bearing ring for detecting physical quantity varying in conjunction with the displacement of a peripheral surface of the rotary bearing ring, and is characterized in that the sensor device comprises a first sensor member and a second sensor member individually detecting the respective physical quantities at axially spaced positions on the peripheral surface of the rotary bearing ring and is connected to a control unit having an arithmetic function to calculate a moment load applied on the wheel based on a difference between detection values obtained by these sensor members.

In this case, the first sensor member and the second sensor member responsible for the detection of the physical quantities varying in conjunction with the displacement of the peripheral surface of the rotary bearing ring are arranged to detect the physical quantities at the axially spaced positions on the peripheral surface of the rotary bearing ring. Therefore, the control unit can calculate the moment load on the wheel based on the difference between the detection values obtained by these sensor members.

In this manner, the moment load applied on the wheel may be determined by using only the first and second sensor members for detecting the physical quantities varying in conjunction with the displacement of the peripheral surface of the rotary bearing ring. Therefore, the measurement of the moment load does not require an additional sensor for detecting the axial displacement of the axial-end face of the rotary bearing ring. Hence, the invention may also be applied to a bearing assembly for driving wheel, to which a constant-velocity joint of a driving shaft is connected. In addition, it is easy to mount a sensor for the other purpose than the load measurement, such as an ABS sensor, to the bearing assembly. Thus is provided a sensor-equipped rolling bearing assembly featuring high generality in this respect.

According to the sensor-equipped rolling bearing assembly of the second aspect of the invention, in a case where the rotary bearing ring is provided with a target portion for producing difference between the detection values from the individual sensor members when the rotary bearing ring is displaced in the same sense of the axial direction, the sensor device may be connected to the control unit also having an arithmetic function to calculate an axial translation load on the wheel based on the difference between the detection values obtained by the individual sensor members.

In this case, the control unit connected with the individual sensor members can also calculate the axial translation load on the wheel based on the difference between the detection values obtained by the respective sensor members. It is therefore possible to calculate both the moment load and the axial translation load on the wheel based on the detection values obtained by the above sensor members. Hence, the number of sensors for the load measurement can be decreased insofar as possible.

More specifically, the sensor-equipped rolling bearing assembly of the second aspect of the invention may employ the target portion, which includes a first annular detection subject confronting a detection surface of the first sensor member and a second annular detection subject confronting a detection surface of the second sensor member.

In this case, the detection subjects may preferably be so configured and located as to vary the detection values from the sensor members in the opposite signs of plus and minus when the rotary bearing ring is displaced in the same sense of the axial direction.

If such detection subjects are employed, a detection value corresponding to an axial unit translation quantity of the rotary bearing ring is amplified by calculating the difference between the detection value from the first sensor member and the detection value from the second sensor member. Thus, the sensor device as a whole can be increased in the detection sensitivity of the axial displacement.

More specifically, the sensor-equipped rolling bearing assembly of the second aspect of the invention may have the following constitution. The first sensor member may comprise a first front sensor and a first rear sensor disposed at a front and a rear position of the rotary bearing ring and a first top sensor and a first bottom sensor disposed at a top and a bottom position of the rotary bearing ring, whereas the second sensor member may comprise a second front sensor and a second rear sensor disposed at a front and a rear position of the rotary bearing ring and a second top sensor and a second bottom sensor disposed at a top and a bottom position of the rotary bearing ring.

In this case, sFy as an independent variable corresponding to a y-axis translation load Fy,
sMz as an independent variable corresponding to a moment load Mz about the z-axis,
sMx as an independent variable corresponding to a moment load Mx about the x-axis,
sFz as an independent variable corresponding to a z-axis translation load Fz, and
sFx as an independent variable corresponding to an x-axis translation load Fx, which will be specifically described by way of the embodiments as below, may be individually calculated based on the following equations (5) to (9) obtained using the eight detection values fᵢ, rᵢ, tᵢ, bᵢ, fₒ, rₒ, tₒ and bₒ given by the individual sensors:
   sFy=(fᵢ+rᵢ+tᵢ+bᵢ)−(fₒ+rₒ+tₒ+bₒ) (5)
   sMz=−mz×kz (6)
   sMx=mx×kx (7)
   sFz=zᵢ−mx×kx (8)
   sFx=xᵢ−mz×kz (9),
   provided that the x-axis is a fore-aft horizontal direction of the wheel, that the y-axis is a lateral horizontal direction (axial direction) of the wheel, and that the z-axis is a vertical direction of the wheel (see FIG. 21).

As will be described hereinlater, the above five independent variables sFx, sFy, sFz, sMx and sMz are in linear independent relation with Fx, Fy, Fz, Mx and Mz as actual loads (five component forces) applied to the wheel (see FIG. 20). Therefore, if these independent variables sFx, sFy, sFz, sMx and sMz are determined, the five component forces Fx, Fy, Fz, Mx and Mz may be calculated by solving first-degree simultaneous equations with these five component forces Fx, Fy, Fz, Mx and Mz being regarded as unknowns.

Therefore, an arithmetic circuit (hardware) and a control program (software) for solving the above equations (5) to (9) and first-degree simultaneous equations with the five unknowns may be installed in the control unit such as an ECU, whereby the loads Fx, Fy, Fz, Mx and Mz actually applied to the wheel can be determined based on the eight detection values fᵢ, rᵢ, tᵢ, bᵢ, fₒ, rₒ, tₒ and bₒ given by the individual sensors.

The sensor-equipped rolling bearing assembly of the second aspect of the invention may preferably have a structure wherein the individual sensor members are mounted to a single case member, whereas the case member is mounted to an inboard end of the fixed bearing ring.

In this case, the individual sensor members can be mounted to the fixed bearing ring by merely mounting the case member having the individual sensor members to the inboard end of the fixed bearing ring. This negates the need for discretely mounting the sensor members to the fixed bearing ring or the need for forming the sensor mounting through-holes in the fixed bearing ring. Furthermore, the bearing assembly is easy to assemble because the individual sensor members are positioned relative to the rotary bearing ring by mounting the case member to the fixed bearing ring.

What is more, the individual sensor members in this case are adapted to detect the physical quantities associated with deformation behavior of the inboard end of the rotary bearing ring, which exhibits a greater deformation behavior under external force than the axially central portion (portion near a bearing center) of the rotary bearing ring. Hence, the sensor members can be increased in the detection accuracies of the physical quantities.

According to the sensor-equipped rolling bearing assembly of the second aspect of the invention, a sensor element constituting each of the sensor members is not particularly limited but it is preferred to employ the inductance-type displacement sensor. Such an inductance-type displacement sensor is less susceptible to the earth magnetism. Particularly in a case where the bearing assembly is applied to the vehicle such as the automotive vehicle which moves as freely changing the traveling direction thereof, the bearing assembly may be prevented from suffering instable control due to noises caused by the influence of the earth magnetism.

If the above inductance-type displacement sensor is constituted by serially connecting plural coil elements arranged circumferentially of the sensor and each having an independent detection surface, the density of magnetic field produced in one displacement sensor is increased so that the sensor can be increased in the detection sensitivity of the gap between itself and the target portion.

Further, according to the sensor-equipped rolling bearing assembly of the second aspect of the invention, the detection subjects disposed at the target portion may comprise annular grooves, ridges or slant surfaces formed along a circumferential direction of the target portion, the slant surfaces inclined in mutually different directions. Furthermore, each of the detection subjects may also comprise an annular band formed from a material having a different magnetic permeability from that of a material constituting its neighboring portion.

In the former case of the annular groove, ridge or slant surface, the detection subject offers an advantage of easy processing and low manufacture cost as compared with the latter case. On the other hand, the latter case offers an advantage that the variation of the physical quantity (such as the inductance in the case of the inductance-type displacement sensor) corresponding to an axial unit movement quantity is greater as compared with the former case, so that the detection sensitivity of the physical quantity is increased.

### BRIEF DESCRIPTION OF THE DRAWINGS

FIG. 1 is a sectional view showing a sensor-equipped rolling bearing assembly according to one embodiment of a first aspect of the invention;

FIG. 2 is a view of the bearing assembly of FIG. 1 as seen from an inboard along an axial direction;

FIG. 3 is a view of the bearing assembly of FIG. 2, showing a state where a cover member of a case member is removed;

FIG. 4 is a sectional view showing a sensor-equipped rolling bearing assembly according to another embodiment of the first aspect of the invention;

FIG. 5 is a fragmentary sectional view showing a sensor-equipped rolling bearing assembly according to yet another embodiment of the first aspect of the invention;

FIG. 6 is a fragmentary sectional view showing a sensor-equipped rolling bearing assembly according to yet another embodiment of the first aspect of the invention;

FIG. 7 is a sectional view showing a sensor-equipped rolling bearing assembly according to still another embodiment of the first aspect of the invention;

FIG. 8 is a group of graphs showing the displacement of a rotary bearing ring as determined from values outputted from individual sensors when force/moment is applied to a wheel mounted to the rotary bearing ring;

FIG. 9 is a sectional side elevation showing a sensor-equipped rolling bearing assembly according to one embodiment of a second aspect of the invention;

FIG. 10a is an enlarged sectional view of a sensor portion of the above bearing assembly, whereas FIG. 10b is a diagram showing a positional relation between a sensor member and an annular groove;

FIG. 11 is a view of the above bearing assembly as seen from the inboard side;

FIG. 12 is a view of the above bearing assembly with a cover member being removed therefrom, as seen from the inboard side;

FIG. 13a is a circuit diagram showing an exemplary gap-detecting circuit of a sensor device, whereas FIG. 13b is an explanatory diagram of a function of a coil element;

FIG. 14a and FIG. 14b are diagrams showing the respective locations of displacement sensors and illustrating the definitions of detection values therefrom;

FIG. 15a is a group of graphs showing sFy calculation method, whereas FIG. 15b is a diagram showing a deformation behavior of a rotary bearing ring caused by a load Fy;

FIG. 16 is a diagram illustrating how the rotary bearing ring is deformed under net moment;

FIG. 17 is a diagram showing how the rotary bearing ring is deformed under a moment load and a translation load;

FIG. 18a shows linear graphs of mz and xᵢ under pure moment; FIG. 18b shows linear graphs of mx and zᵢ under pure moment; and FIG. 18c shows equations for calculating correction coefficients kz and kx;

FIG. 19 is a block diagram showing a calculation method taken by a control unit;

FIG. 20 shows matrix charts each representing a correlation between an independent variable calculated from sensor output and an actual load applied to the wheel;

FIG. 21 is a perspective view of the wheel for illustrating the definitions of x-axis direction, y-axis direction and z-axis direction along with loads in the respective directions; and

FIG. 22a is a diagram showing an exemplary modification of a detection subject and a positional relation between a sensor member and an annular band; FIG. 22b is a diagram showing an exemplary modification of the detection subject and a positional relation between the sensor member and a ridge; and FIG. 22c is a diagram showing an exemplary modification of the detection subject and a positional relation between the sensor member and a slant surface.

### DETAILED DESCRIPTION

A sensor-equipped rolling bearing assembly (hereinafter, also referred to simply as “bearing assembly”) according to an embodiment of the invention will hereinbelow be described with reference to the accompanying drawings.

Bearing Assembly in a First Aspect

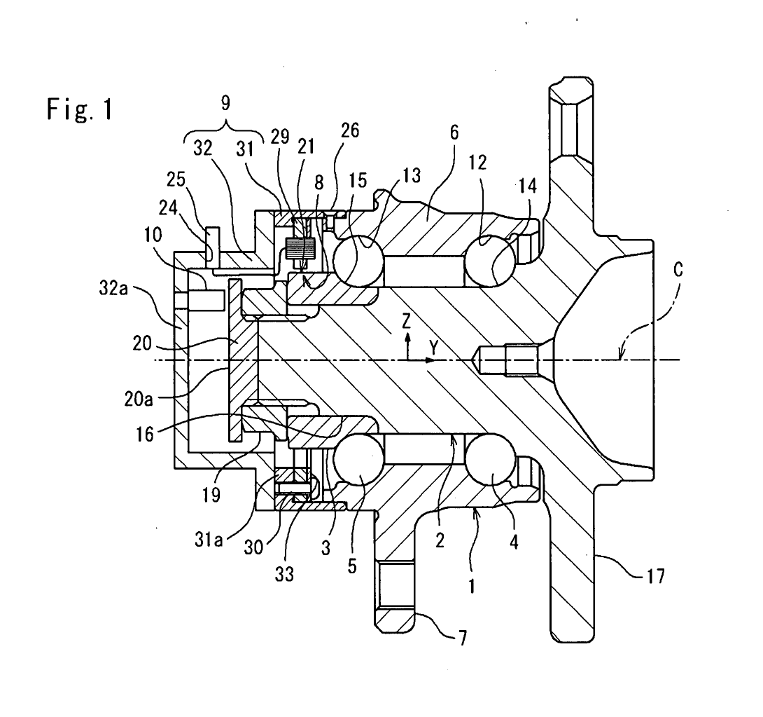

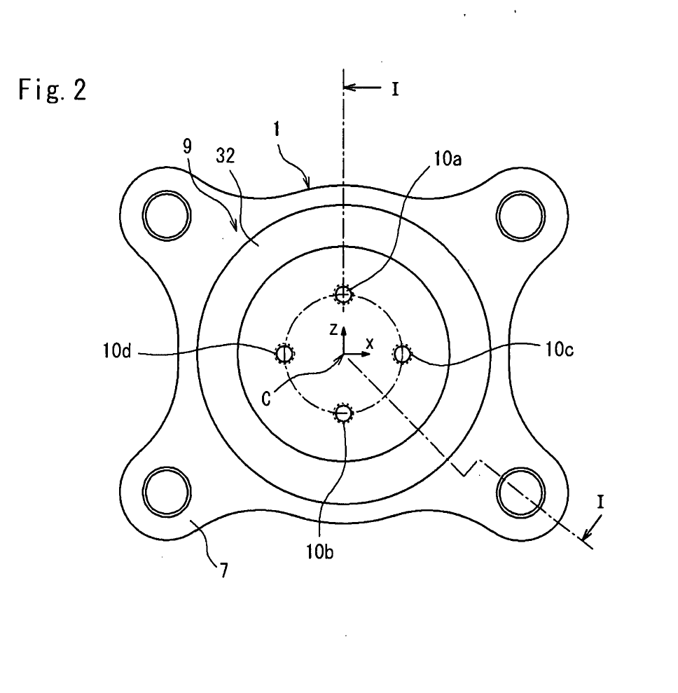

FIG. 1 is a sectional view showing a bearing assembly according to one embodiment of a first aspect of the invention. FIG. 2 is a view of this bearing assembly as seen from an inboard side along an axial direction thereof. In FIG. 1, the right-hand side is an outboard side with respect to a vehicle, whereas the left-hand side is an inboard side with respect to the vehicle.

The bearing assembly according to the embodiment includes: a cylindrical outer ring 1; an inner shaft 2 inserted through the outer ring 1; an inner ring member 3 fitted about an inboard end of the inner shaft 2; double rows of rolling elements 4, 5, each row including plural balls. These components constitute a double-row angular ball bearing. The balls in each row as the rolling element 4 or 5 are retained by a cage (not shown) as circumferentially arranged at predetermined space intervals.

According to the invention, a direction along a centerline C of the bearing assembly is defined as Y-axis, a horizontal direction orthogonal to the Y-axis is defined as X-axis, and a direction orthogonal to both the Y-axis and X-axis is defined as Z-axis. That is, the Y-axis defines a transversely horizontal direction of the vehicle, the X-axis defines a front-rear horizontal direction thereof, and the Z-axis defines a vertical direction thereof.

In this bearing assembly, the outer ring 1 constitutes a fixed bearing ring fixed to a vehicle body, whereas the inner shaft 2 and the inner ring member 3 constitute a rotary bearing ring disposed on a wheel side. The double rows of rolling elements 4, 5 are rollably interposed between the fixed bearing ring and the rotary bearing ring. Thus, the fixed bearing ring and the rotary bearing ring are disposed in coaxial relation such that the rotary bearing ring along with the wheel (not shown) is free to rotate relative to the fixed bearing ring.

The inner shaft 2 includes a flange 17 which radially outwardly extends from an outboard side thereof. The flange 17 serves as a mounting portion for the wheel and a brake disk. The wheel and such are mounted to the flange 17 by means of unillustrated bolts. The inner ring member 3 is fitted about the inner shaft 2 at an inboard portion thereof. The inner ring member 3 is secured to the inner shaft 2 by means of a nut 19 threadedly engaged with the inboard end of the inner shaft 2. Respective inner raceway surfaces 14, 15 for the rolling elements 4, 5 are formed on outside surfaces of the inner shaft 2 and of the inner ring member 3.

The outer ring 1 includes: a cylindrical body 6, an inside surface of which is formed with outer raceway surfaces 12, 13 for the rolling elements 4, 5; and a flange 7 extending radially outwardly from an outside surface of the body 6. The flange 7 is fixed to a knuckle (not shown) of a suspension as a vehicular member.

The bearing assembly is provided with a case member 9 on its inboard side. The case member 9 possesses a plurality of displacement sensors for detecting gaps between themselves and an outside surface of an inboard end of the fixed bearing ring. The case member 9 is constituted by a cylinder member 31 and a cover member 32. The cylinder member 31 is a cylindrical member short in the axial direction. The cylinder member 31 has one end thereof fixed to an inboard end of the outer ring 1 by means of a fixing screw 26, so as to be fixed coaxially with the outer ring 1. The cover member 32 is fixed to the other end of the cylinder member 31. The cover member 32 is mounted in a manner to cap the cylinder member 31 thereby preventing the invasion of foreign substances into a bearing portion.

A plural number of radial displacement sensors 8 for detecting gaps between themselves and an outside surface of an inboard end of the rotary bearing ring are mounted to an inside surface of the cylinder member 31 of the case member 9.

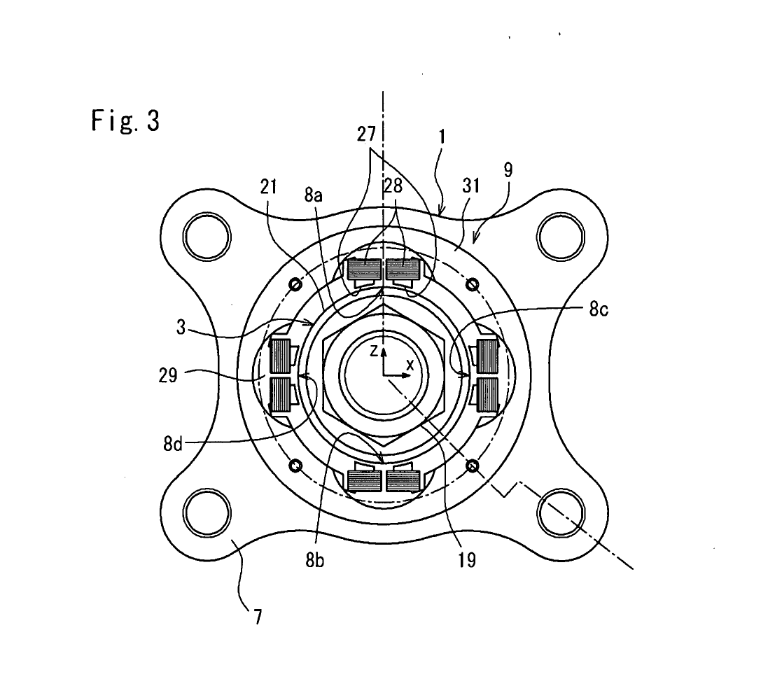

FIG. 3 shows a state where the cover member 32 of the case member 9 is removed from the bearing assembly. Referring to FIG. 3, the radial displacement sensors 8 (8a, 8b, 8c, 8d) are arranged circumferentially of the case member 9 at predetermined space intervals (90°). Specifically, the radial displacement sensors 8 are disposed at four places including front, rear, top and bottom positions such that the displacement sensors can detect plus or minus variations of radial gaps between themselves and the outside surface of the inboard end of the rotary bearing ring with respect to the X-axis and Z-axis directions. These four displacement sensors 8 regard an outside surface of the inner ring member 3 of the rotary bearing ring as a measurement subject 21, and detect gaps between themselves and the outside surface of the inner ring member for determination of radial displacement of the rotary bearing ring. Specifically, the case member 9 is mounted to the inboard end of the outer ring 1 such that the outside surface of the inner ring member 3 may serve as the subject of measurement 21 taken by the displacement sensors 8, which detect gaps between themselves and a shoulder portion of the inner ring member 3.

Now, description is made on the outside surface of the inner ring member 3. Referring to FIG. 1, a recessed circumferential groove as the inner raceway surface 15 for the rolling element 5 is formed on the outboard side, whereas the measurement subject 21 is formed on the inboard side as defined by an outside surface portion extending straight in parallel to the axial (Y-axis) direction. The inner ring member 3 has a greater axial dimension than that of a stepped small-radius portion 16 which is formed on the inner shaft 2 for allowing the inner ring member 3 to be fitted about the inner shaft. That is, the inner ring member 3 is a cylindrical member longer than a conventional inner ring member.

Next, description is made on the radial displacement sensor 8. The displacement sensor 8 is an inductance-type displacement sensor, which is capable of detecting the variations of the gap between itself and the outside surface of the inner ring member 3 based on inductance variations. More specifically, the displacement sensor 8 includes a pair of magnetic poles 27 adjoining each other in a circumferential direction and each having a sensor coil 28 wound thereabout, as shown in FIG. 1 and FIG. 3. The displacement sensors 8 are disposed at the front, rear, top and bottom positions of the bearing assembly. These magnetic-pole pairs 27 are so formed as to project radially inwardly from a single annular plate 29 and to have their radially inward end-faces confronting the outside surface of the inner ring member 3 via the radial gap. That is, the individual magnetic-poles 27 of the radial displacement sensors 8 are formed integrally with the metallic annular plate 29, so that the displacement sensors 8 are adapted to detect the gaps between themselves and the outside surface of the inner ring member 3 with respect to the radial directions (X-axis direction and Z-axis direction). The annular plate 29 is fixed to the cylinder member 31 by means of a fixing screw 30 as sandwiched between an inside jaw 31a of the cylinder member 31 and an annular base plate 33.

In this manner, the plural radial displacement sensors 8 are unified with the case member 9, thus negating the need for adjustment of the circumferential positions thereof or the need for adjustment of the radial positions thereof (distance to the outside surface of the inner ring member 3) in the assembly work of the bearing assembly. Since the plural displacement sensors 8 are assembled to the case member 9, the individual displacement sensors 8 can be positioned relative to the measurement subject 21 by mounting the case member 9 to the outer ring 1. This results in an easy assembly work.

According to the above constitution, when a Z-axis load is applied to the rotary bearing ring, Z-axis gaps between the radial top displacement sensor 8a and the detection subject 21 and between the radial bottom displacement sensor 8b and the detection subject 21 are varied (plus-minus displacements), while the radial displacement sensors 8a, 8b are able to detect such displacements. When an X-axis load is applied to the rotary bearing ring, X-axis gaps between the radial front displacement sensor 8c and the detection subject 21 and between the radial rear displacement sensor 8d and the detection subject 21 are varied (plus-minus displacements), while the radial displacement sensors 8c, 8d are able to measure such displacements. Further, the case member 9 assembled with the displacement sensors 8 is disposed at an end portion of the bearing assembly so as to be spaced away from the flange 7 and the flange 17. Hence, the case member is less affected by strain of peripheral portions, thus allowing the sensors to detect the above gap variations (plus-minus displacements) with high accuracies.

The case member 9 of the bearing assembly shown in FIG. 1 further includes a second displacement sensor 10 (axial displacement sensor) for detecting a gap between itself and an axial-end face of the inboard end of the rotary bearing ring. This displacement sensor 10 is mounted to the cover member 32 of the case member 9. The displacement sensor is fixed to a bottom plate 32a of the cover member 32 for detecting the gap between itself and the axial-end face of the rotary bearing ring with respect to a direction parallel to the axial direction (Y-axis direction). A measurement subject for the displacement sensor 10 is defined by the inboard axial-end face of the rotary bearing ring. The axial-end face is defined by a plate member 20 fixed to (threadedly engaged with) the nut 19. The plate member 20 has a flat plane 20a orthogonal to the axial direction. The flat plane 20a is the measurement subject for the axial displacement sensor 10. Similarly to the radial displacement sensors 8, the axial displacement sensor 10 is an inductance-type displacement sensor, which is capable of detecting inductance variations in the sensor coils thereof. Thus, each axial displacement sensor 10 is adapted to measure the axial (Y-axis) displacement of the rotary bearing ring, so that an axial load on the wheel can be determined.

An alternative arrangement may be made such that the plate member 20 is obviated whereas an inboard axial-end face of the inner ring member 3 or the like is used as the measurement subject for the axial displacement sensor 10.

Referring to FIG. 2, the axial displacement sensors 10 are disposed at top and bottom places (10a, 10b) and in a concentric relation. This provides for the determination of a moment about X-axis Mx of the rotary bearing ring relative to the fixed bearing ring. The axial displacement sensors 10 may also be disposed at four places including top, bottom, front and rear places (10a, 10b, 10c, 10d). This provides for the determination of a moment about X-axis Mx and a moment about Z-axis Mz of the rotary bearing ring relative to the fixed bearing ring. Specifically, when the moment about X-axis Mx is applied to the rotary bearing ring, the respective gaps between the axial top displacement sensor 10a and the detection subject and between the axial bottom displacement sensor 10b and the detection subject are varied, while the axial displacement sensors 10a, 10b are adapted to measure such gap variations. When the moment about Z-axis Mz is applied, the respective gaps between the axial front displacement sensor 10c and the detection subject and between the axial rear displacement sensor 10d and the detection subject are varied, while the axial displacement sensors 10c, 10d are adapted to measure such gap variations.

According to the above constitution of the bearing assembly, the radial displacement sensors 8 are adapted to take measurements on the gap variations caused by the radial load applied to the wheel in terms of the radial displacement of the inner ring member 3. In a case where the inner shaft 2 and the inner ring member 3 are displaced in a manner to incline relative to the outer ring 1 (are subjected to the moment), the gap is varied more (amplified) at the inner ring member 3 at the inboard end than at an axially central portion of the inner shaft 2 (portion between the rolling elements 4, 5). Therefore, the accuracy of the measurements taken by the displacement sensors 8 can be increased by using the outside surface of the inner ring member 3 as the measurement subject 21.

Since the displacement sensors 8, 10 are of the inductance type which is less susceptible to the earth magnetism, a constitution less susceptible to the earth magnetism can be embodied by mounting the bearing assembly equipped with this sensor to the vehicle such as the automotive vehicle which moves as freely changing the traveling direction thereof. Furthermore, the displacement sensor featuring high durability can be embodied.

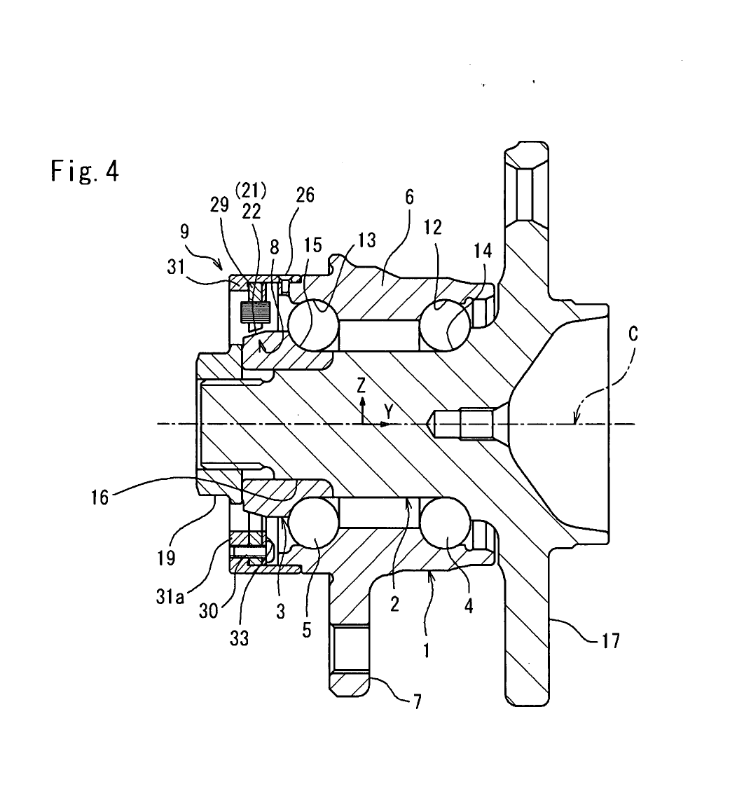

FIG. 4 is a sectional view showing a bearing assembly according to another embodiment of the first aspect of the invention. The bearing assembly is generally constituted the same way as the first embodiment shown in FIG. 1 but differs therefrom in that the measurement subject 21 for the displacement sensor 8 is defined by a slant surface, that the displacement sensor 8 has an inside end face formed in parallel to this slant surface as defining a gap therebetween, and that the axial displacement sensor is dispensed with. FIG. 4 omits the depiction of the cover member 32 of the case member 9. This embodiment may also be arranged to omit the cover member 32.

In this bearing assembly, an outside surface of an inboard end of the inner ring member 3 is formed as a straight slant surface inclined relative to the centerline C, while this slant surface is used as a measurement plane 22 for the displacement sensor 8. The configuration of the measurement plane 22 permits the gap between the plane and the radial displacement sensor 8 to be varied in both of the radial direction and the axial direction when the load is applied to the rotary bearing ring. Thus, the radial displacement sensor 8 is adapted to detect gap variations in both of the radial direction and the axial direction. Hence, a radial displacement and an axial displacement of the rotary bearing ring can be detected by the radial displacement sensor 8.

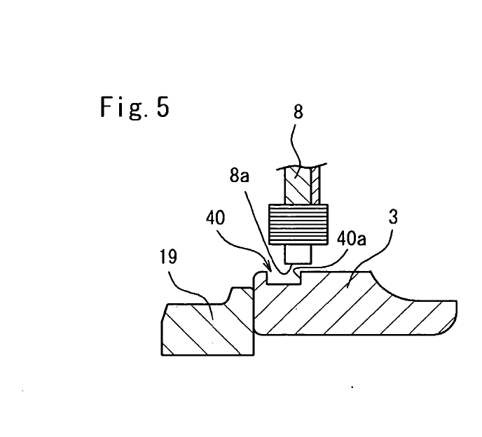

FIG. 5 is a fragmentary sectional view showing a bearing assembly according to still another embodiment of the first aspect of the invention. This embodiment also omits the axial displacement sensor similarly to the embodiment shown in FIG. 4. Instead, the outside surface of the inboard end of the inner ring member 3 constituting the rotary bearing ring is formed with an annular recess 40 at place confronted by the plural displacement sensors 8. The annular recess 40 is formed in face-to-face relation with a tip face 8a of the displacement sensor 8. More specifically, a center of the tip face 8a with respect to the axial direction (the axial direction of the bearing assembly) is located above a vehicle-inboard wall 40a of the annular recess 40. Such a configuration permits the displacement sensor 8 to detect the axial displacement of the inner ring member 3 because the displacement sensor 8 defines different gaps with respect to the outside surface of the inner ring member 3 and a bottom of the annular recess 40. That is, the displacement sensor disposed radially of the rotary bearing ring can be used for detecting the quantity of axial displacement of the rotary bearing ring.

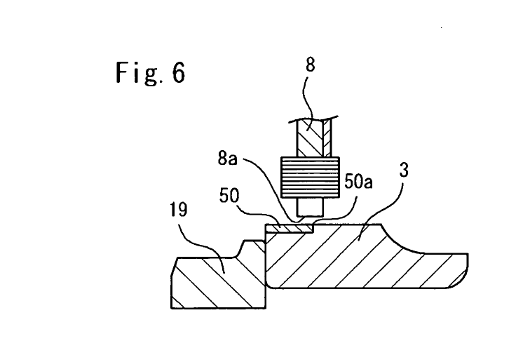

FIG. 6 is a fragmentary sectional view showing a bearing assembly according to yet another embodiment of the first aspect of the invention. This embodiment also omits the axial displacement sensor just as the embodiment shown in FIG. 4. Instead, an annular band 50 is formed in the outside surface of the inboard end of the inner ring member 3 constituting the rotary bearing ring and disposed at place confronted by the plural displacement sensors 8. The annular band is formed from a different material from that of the inner ring member 3. The annular band 50 is formed in face-to-face relation with the tip face 8a of the displacement sensor 8. More specifically, the center of the tip face 8a with respect to the axial direction (the axial direction of the bearing assembly) is located above a vehicle-inboard edge 50a of the annular band 50. In addition, the inductance-type displacement sensor is used as the displacement sensor 8.

The formation of the annular band 50 from the different material from that of the inner ring member 3 can be implemented by, for example, varying a carbon content of the material forming the inner ring member 3. Specifically, in a case where the inner ring member 3 is manufactured by carburizing and quenching low carbon steel, the inner ring member can be coated with anticarburizing compounds at its portion where the annular band 50 is to be formed. After the anticarburizing treatment, the inner ring member can be subjected to the carburizing and quenching process, whereby the carbon content of the annular band 50 can be decreased from that of the other portion which is not subjected to the anticarburizing treatment. The low carbon steel normally has a carbon content in the range of 0.1 to 0.2%. However, the carbon content of the low carbon steel is increased to about 0.7 to 0.8% by carburizing the steel. Since the portion having the greater carbon content is less transmissive to line of magnetic force than the portion having the smaller carbon content. Hence, the formation of the annular band 50 provides for the detection of the axial displacement of the inner ring member 3. That is, the displacement sensor disposed radially of the rotary bearing ring can be used for detecting the quantity of axial displacement of the rotary bearing ring. In the embodiment shown in FIG. 6, an eddy-current displacement sensor may also be used as the displacement sensor.

The embodiments shown in FIG. 5 and FIG. 6 may also be arranged such that some of the plural displacement sensors 8 are disposed in face-to-face relation with the annular recess 40 or the annular band 50 whereas the remaining displacement sensors 8 are not disposed opposite the annular recess 40 or the annular band 50. Such an arrangement provides for the variations of output pattern of the sensors.

While illustration is omitted, the outside surface of the inner ring member 3 may also have any other configuration than the slant surface in order to produce both the radial and the axial variations of the gap between the outside surface and the radial displacement sensors 8 when the load is applied to the rotary bearing ring. For example, the outside surface of the inner ring member may be formed with a recessed circumferential groove. In this case, an arrangement may be made such that the displacement sensor 8 has its radially inside end positioned in the recessed circumferential groove so as to detect the radial gap variation associated with radial displacement of a bottom of the recessed circumferential groove and to detect the axial gap variation associated with axial displacement of a lateral side of the recessed circumferential groove.

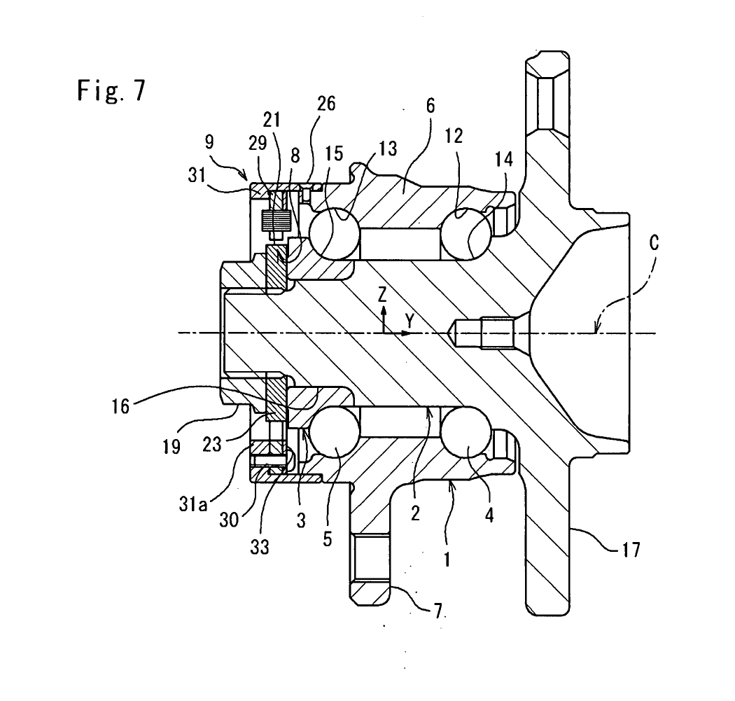

FIG. 7 is a sectional view showing a bearing assembly according to still another embodiment of the first aspect of the invention. The bearing assembly is generally constituted the same way as the first embodiment shown in FIG. 1 but differs therefrom in that an annular measurement subject member 23 is fitted about the inboard end of the rotary bearing ring as sandwiched between the inner ring member 3 and the nut 19, whereas the radial displacement sensor 8 is adapted to detect a gap between itself and an outside surface of the measurement subject member 23. The figure omits the depiction of the cover member 32 of the case member 9, the plate member 20 and the axial displacement sensor 10.

This annular measurement subject member 23 is a member (material) which produces a greater inductance variation in the displacement sensor 8 than the inner ring member 3 does. Specifically, the inner ring member 3 is formed from bearing steel, whereas the measurement subject member 23 is formed of a silicon steel sheet. Thus, the displacement sensor 8 is increased in measurement accuracies. The axial displacement can be measured by means of the same axial displacement sensor (not shown) and plate member (not shown) as those shown in FIG. 1. In these embodiments, the plate member may be formed from the same material as that of the measurement subject member 23.

While illustration is omitted, an arrangement may be made such that the same slant surface as that shown in FIG. 4 or the unillustrated recessed circumferential groove (measurement plane 22) is formed in an outside surface of the annular measurement subject member 23 such that the radial displacement sensor 8 can take measurements on the radial gap and the axial gap between itself and the rotary bearing ring. In this case, the axial displacement sensor can be dispensed with.

In the individual embodiments of the aforementioned constitutions, correlation between the load acting on the tire (tire force) and the displacement of the rotary bearing ring can be previously established whereby the load can be determined. Specifically, the aforesaid displacement sensors can be used to determine X-axis, Y-axis and Z-axis components (Fsx, Fsy Fsz, Msx, Msz) of the load applied to the rotary bearing ring. Now, description is made on the determination of the load components based on the embodiment shown in FIG. 1 to FIG. 3.

The radial displacement sensors 8c, 8d at the front and rear positions, the radial displacement sensors 8a, 8b at the top and bottom positions and the axial displacement 10a, 10b at the top and bottom positions are connected to an arithmetic processing unit (not shown). The arithmetic processing unit may be implemented in a control unit (ECU) mounted in the vehicle body and is capable of calculating output values from the individual displacement sensors.

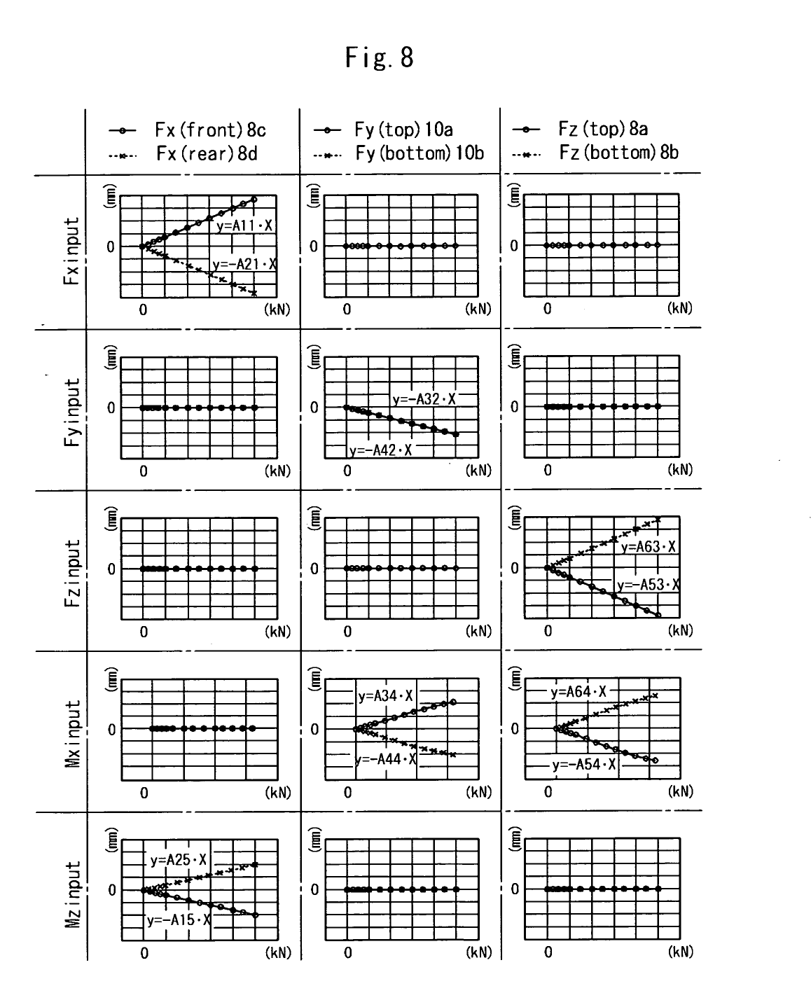

FIG. 8 shows the displacements of the rotary bearing ring as determined from the output values from the individual displacement sensors when the force/moment is applied to the wheel mounted to the rotary bearing ring. Specifically, FIG. 8 graphically represents the individual displacements of the rotary bearing ring as determined from the detection values (gaps) supplied from the radial displacement sensors 8c, 8d at the front and rear positions, the axial displacement sensors 10a, 10b at the top and bottom positions and the radial displacement sensors 8a, 8b at the top and bottom positions when the rotary bearing ring is subjected to the X-axis load (Fx input), Y-axis load (Fy input) and the Z-axis load (Fz input) as the load acting on the wheel and to the moment about the X-axis (Mx input) and the moment about the Z-axis (Mz input) as the moment acting on the wheel.

A general equation (1) represents the correlation of FIG. 8 in the form of a determinant (in an arranged form) A matrix M of the determinant obtained from the results shown in FIG. 8 is represented by an equation (2). Specifically, the equation (1) and equation (2) represent the relation between the individual displacement sensors and the loads/moments in the individual directions in terms of determinant. An equation (3) represents an inverse matrix M⁻¹ of the matrix M. The components with respect to the individual axes (Fsx, Fsy, Fsz, Msx, Mxz) of the load applied to the wheel (rotary bearing ring) can be calculated based on an equation (4) which uses the values supplied from the individual displacement sensors and the inverse matrix M⁻¹.

$$\begin{matrix}[ \begin{matrix}{Fx}_{( front )} \\ {Fx}_{( rear )} \\ {Fy}_{( top )} \\ {Fy}_{( bottom )} \\ {Fz}_{( top )} \\ {Fz}_{( bottom )}\end{matrix} ] = M \cdot [ \begin{matrix}Fx \\ Fy \\ Fz \\ M x \\ Mz\end{matrix} ] \\ provided that , \\ M = [ \begin{matrix}{m}_{11} & {m}_{12} & {m}_{13} & {m}_{14} & {m}_{15} \\ {m}_{21} & {m}_{22} & {m}_{23} & {m}_{24} & {m}_{25} \\ {m}_{31} & {m}_{32} & {m}_{33} & {m}_{34} & {m}_{35} \\ {m}_{41} & {m}_{42} & {m}_{43} & {m}_{44} & {m}_{45} \\ {m}_{51} & {m}_{52} & {m}_{53} & {m}_{54} & {m}_{55} \\ {m}_{61} & {m}_{62} & {m}_{63} & {m}_{64} & {m}_{65}\end{matrix} ] & ( 1 ) \\ M = [ \begin{matrix}{A}_{11} & 0 & 0 & 0 & - {A}_{15} \\ - {A}_{21} & 0 & 0 & 0 & {A}_{25} \\ 0 & - {A}_{32} & 0 & {A}_{34} & 0 \\ 0 & - {A}_{42} & 0 & - {A}_{44} & 0 \\ 0 & 0 & - {A}_{53} & - {A}_{54} & 0 \\ 0 & 0 & {A}_{63} & {A}_{64} & 0\end{matrix} ] & ( 2 ) \\ {M}^{- 1} = [ \begin{matrix}{B}_{11} & - {B}_{11} & 0 & 0 & 0 & 0 \\ 0 & 0 & - {B}_{23} & - {B}_{24} & 0 & 0 \\ 0 & 0 & - {B}_{33} & - {B}_{34} & - {B}_{ 35} & - {B}_{ 36} \\ 0 & 0 & {B}_{43} & {B}_{44} & 0 & 0 \\ - {B}_{51} & {B}_{52} & 0 & 0 & 0 & 0\end{matrix} ] & ( 3 ) \\ [ \begin{matrix}Fsx \\ Fsy \\ Fsz \\ M sx \\ Msz\end{matrix} ] = [ \begin{matrix}{B}_{11} & - {B}_{11} & 0 & 0 & 0 & 0 \\ 0 & 0 & - {B}_{23} & - {B}_{24} & 0 & 0 \\ 0 & 0 & - {B}_{33} & - {B}_{34} & - {B}_{ 35} & - {B}_{ 36} \\ 0 & 0 & {B}_{43} & {B}_{44} & 0 & 0 \\ - {B}_{51} & {B}_{52} & 0 & 0 & 0 & 0\end{matrix} ] [ \begin{matrix}{Fx}_{( front )} \\ {Fx}_{( rear )} \\ {Fy}_{( top )} \\ {Fy}_{( bottom )} \\ {Fz}_{( top )} \\ {Fz}_{( bottom )}\end{matrix} ] & ( 4 )\end{matrix}$$

If the aforementioned displacement sensors and arithmetic processing unit are used, the individual axes-components (Fsx, Fsy, Fsz, Msx, Mxz) of the load (tire force) applied to the wheel (rotary bearing ring) can be calculated based on the calculation using the output values from the individual displacement sensors and the predetermined function (inverse matrix M⁻¹) previously stored in the processing unit. This provides for the determination of the force components in the individual axes-directions even if the front-side and rear-side sensors (the axial displacement sensors 10c, 10d shown in FIG. 3) of the axial displacement sensors 10 are dispensed with. In addition, the radial displacement sensors 8 are symmetrically disposed at the top-bottom positions and the front-rear positions with respect to the centerline C, so that the need for correction for temperature is negated by calculating a difference between the output values from the corresponding sensor pair.

It is also possible to mount an ABS sensor (not shown) to the inboard end of the bearing assembly. In this case, the aforesaid displacement sensors 8, 10 are disposed at the inboard end where the ABS sensor is disposed. Hence, signal lines 25 of these sensors can be concentrated at the case member 9 at the inboard end of the bearing assembly so that the bearing assembly can have a simplified structure. Furthermore, a wiring operation of these signal lines is facilitated.

In addition, a thorough-hole 24 may be formed in the case member 9, as shown in FIG. 1, so that the signal lines 25 from the individual sensors may be led out through this through-hole 24 for external wiring. At this time, the signal lines 25 may be combined to be collectively passed through the through-hole 24. This negates the need for forming a hole for the signal lines 25 in the outer ring 1.

The bearing assembly of the invention is not limited to the illustrated embodiments and may be practiced in any other mode within the scope of the invention. While the foregoing embodiments are described by way of examples where the bearing assemblies are used in a driven wheel, for example, the bearing assembly may also be used in a driving wheel. In this case, the cover member 32 of the case member 9 (see FIG. 1) is formed as an annular member (not shown) fitted about a shaft for driving the wheel (rotary bearing ring) into rotation, whereas a seal member is interposed between these members.

Bearing Assembly in a Second Aspect

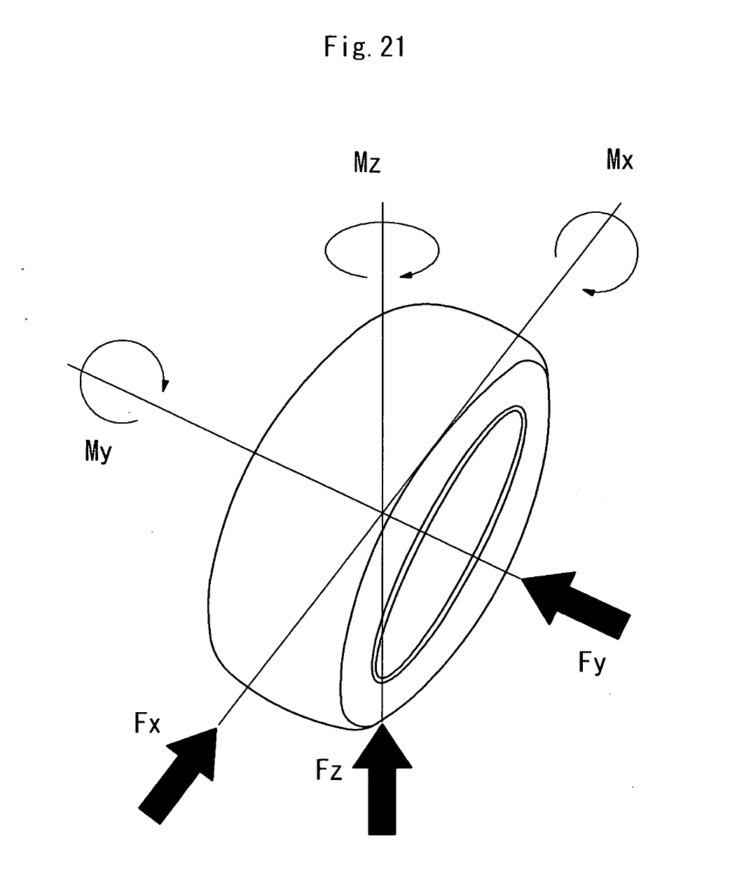

According to the bearing assembly shown in FIG. 1, the displacement sensors for detecting the axial displacement of the rotary bearing ring with respect to the axial-end face thereof is disposed at the case member for closing the inboard end of the fixed bearing ring. This makes it possible to determine not only the translation load acting vertically on the wheel but also the moment load about the front-rear direction (x-axis in FIG. 21) and the moment load about the vertical direction (z-axis in FIG. 21) which occur due to a centrifugal force associated with cornering of the vehicle, and the translation load in the axial direction of the wheel (Fy in FIG. 21).

However, the following problem is encountered by the means permitting the additional installation of the displacement sensor for detecting the axial displacement of the rotary bearing ring with respect to the axial-end face thereof. That is, the means may be adopted by the bearing assembly for driven wheel wherein the axial-end face of the rotary bearing ring defines a free end. However, the means may not be adopted by the bearing assembly for driving wheel wherein the axial-end face of the rotary bearing ring is coupled with a constant-velocity joint of a drive shaft. Furthermore, even the bearing assembly for driven wheel also has a problem that it is difficult to mount a sensor for the other purpose than load measurement, such as the ABS sensor.

In this connection, a bearing assembly according to a second aspect of the invention for overcoming these drawbacks is so arranged that a sensor device mounted to the fixed bearing ring includes a first sensor member and a second sensor member individually detecting physical quantities at axially spaced positions on a peripheral surface of the rotary bearing ring and is connected to a control unit having an arithmetic function to calculate a moment load on the wheel based on a difference between detection values obtained by these sensor members.

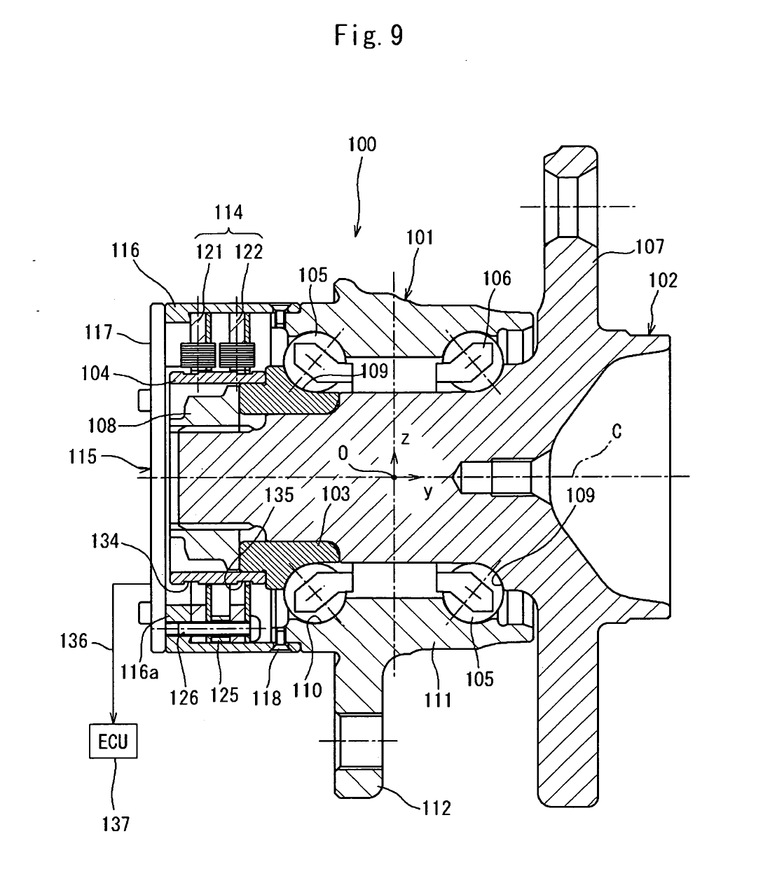

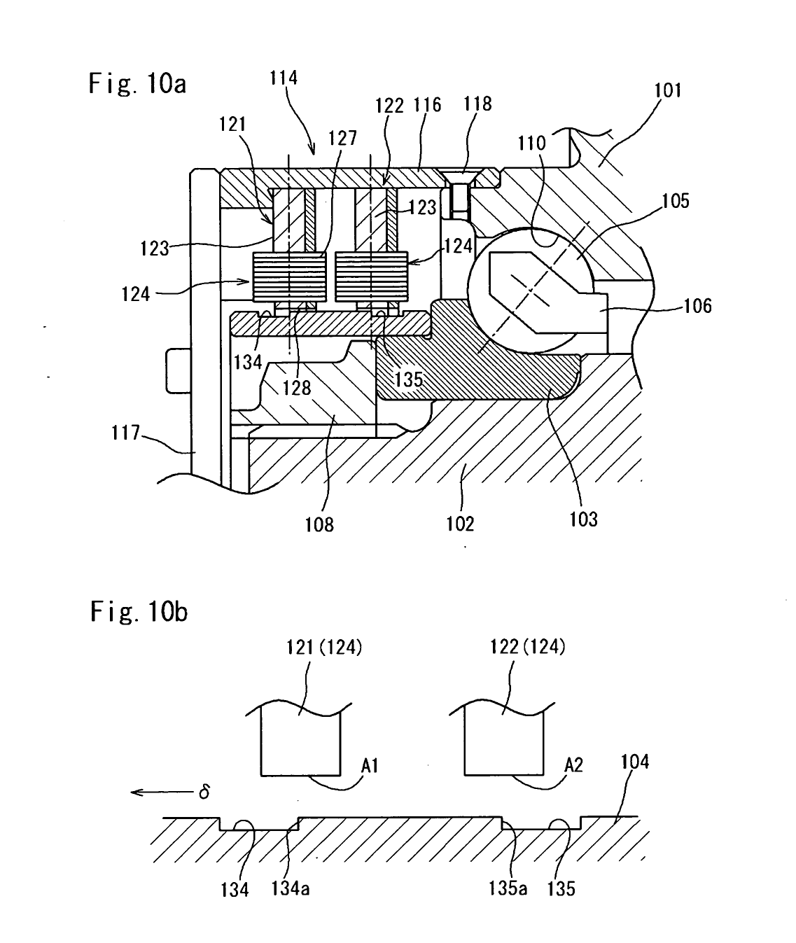

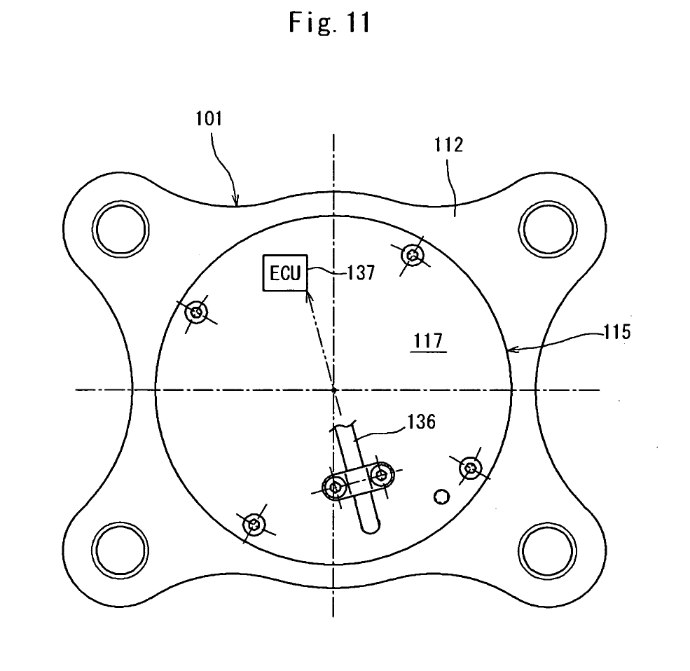

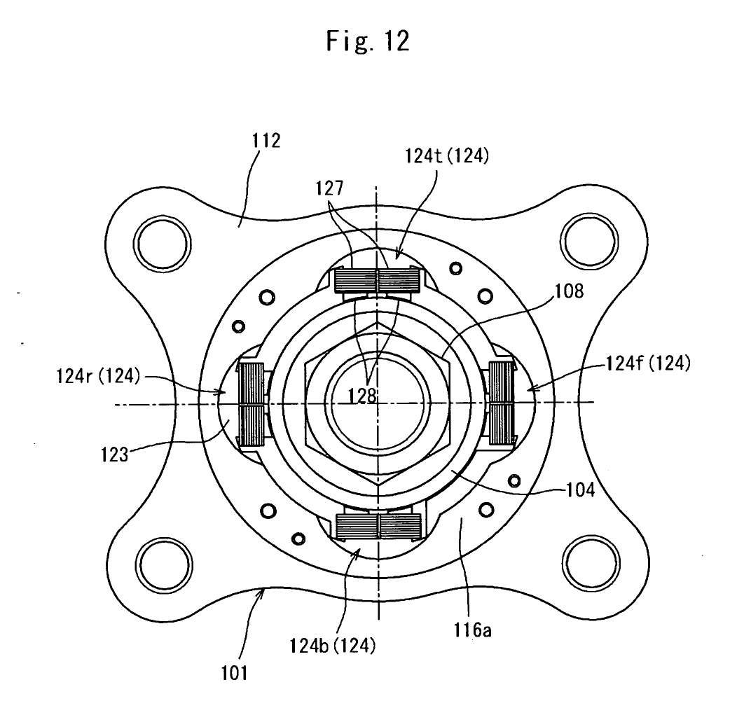

FIG. 9 is a sectional side elevation showing the bearing assembly according to the second aspect of the invention. FIG. 10a and FIG. 10b are enlarged sectional views showing a sensor portion of the bearing assembly. FIG. 11 is a view of the bearing assembly as seen from an inboard side. FIG. 12 is a view of the bearing assembly with a cover member 117 (to be described hereinlater) being removed therefrom, as seen from the inboard side. It is noted that the right-hand side as seen in FIG. 9 is the outboard side (the outer side of the vehicle) whereas the left-hand side as seen in the figure is the inboard side (the inner side of the vehicle).

As shown in FIG. 9, a bearing assembly 100 according to the embodiment includes: a cylindrical outer ring 101; an inner shaft 102 rotatably inserted through the outer ring 101; an inner ring member 103 fitted about an inboard end of the inner shaft 102; a target portion 104 fitted about an inboard end of the inner ring member 103; and plural rows of rolling elements 105, 105 each including plural balls arranged circumferentially. These components constitute a double-row angular ball bearing portion. The balls in each row, as the rolling element 105, 105, are retained by a cage 106 as circumferentially arranged at predetermined space intervals.

In the bearing assembly 100 of the embodiment, the outer ring 101 constitutes the fixed bearing ring fixed to the vehicle body. On the other hand, the inner shaft 102, the inner ring member 103 and the target portion 104 constitute the rotary bearing ring disposed on the wheel side. The plural rows of rolling elements 105, 105 are rollably interposed between the fixed bearing ring and the rotary bearing ring. Thus, the fixed bearing ring and the rotary bearing ring are positioned in coaxial relation. The rotary bearing ring is free to rotate together with the wheel (a tire and a tire wheel shown in FIG. 21) relative to the fixed bearing ring.

The inner shaft 102 constituting the rotary bearing ring has a flange 107 extending radially outwardly from the outboard side thereof. The flange 107 defines a mounting portion to which the tire wheel of the wheel and a brake disk are mounted. The tire wheel and such are mounted to the flange 107 by means of an unillustrated fixing bolt. The inner ring member 103 is fitted about a step portion formed on an inboard side of the inner shaft 102. The inner ring member 103 is secured to the inner shaft 102 by means of a nut 108 threadedly engaged with an inboard end of the inner shaft 102. Respective inner raceway surfaces 109, 109 for rolling elements 105, 105 are formed on respective outside surfaces of the inner shaft 102 and the inner ring member 103.

The outer ring 101 constituting the fixed bearing ring includes: a cylindrical body 111 having outer raceway surfaces 110, 110 for the rolling elements 105, 105 formed on an inside surface thereof; and a flange 112 extending radially outwardly from an outside surface of the cylindrical body 111. The flange 112 is fixed to a knuckle (not shown) of a suspension as a vehicular-side member, whereby the bearing assembly 100 is fixed to the vehicle body.

The bearing assembly 100 of the embodiment includes: a sensor device 114 for detecting a physical quantity varying in conjunction with the displacement of an outside surface of the target portion 104 disposed on the rotary bearing ring (the embodiment defines the physical quantity as inductance varying in conjunction with a gap between the device and an outside surface of the target portion 104); and a case member 115 for mounting the sensor device 114 to the outer ring 101 as the fixed bearing ring.

As shown in FIG. 9, FIG. 10a and FIG. 10b, the case member 115 includes a short cylinder member 116 and a disk-like cover member 117. The cylinder member 116 consists of a cylindrical metal member having a short axial length. The cylinder member 116 has an opening on one end thereof fixed to an inboard end of the outer ring 101 by means of a fixing screw 118 in a manner to establish coaxial relation with the outer ring 101. The cover member 117 is a member for closing an opening at the other end of the cylinder member 116, thus serving to prevent the invasion of foreign substances into the bearing assembly 100.

The sensor device 114 is mounted to an inside surface of the cylinder member 116 of the case member 115 for the purpose of detecting a gap between itself and the outside surface of the target portion 104 fixed to the inboard end of the inner shaft 102.

As shown in FIG. 10a, FIG. 10b and FIG. 12, the sensor device 114 of the embodiment includes a first sensor member 121 and a second sensor member 122 which detect respective gaps as determined at axially spaced positions on the outside surface of the target portion 104. It is noted herein that the term “first”, concerning the sensor device 114 and the target portion 104, means the inboard side whereas the term “second” means the outboard side.

The first and second sensor members 121, 122 are inductance-type displacement sensors which each detect the variations of the gap between itself and the outside surface of the target portion 104 based on inductance variations. The first and second sensor members include: sensor rings 123 mounted to the inside surface of the cylinder member 116 in axially spaced two lines; and a plurality of displacement sensors 124 (four sensors in this embodiment) arranged circumferentially of each sensor ring 123 at predetermined space intervals. The sensor rings 123 are fixed to a jaw 116a of the cylinder member 116 by means of a fixing screw 126 as sandwiching a cylindrical spacer 125 therebetween (FIG. 9).

The displacement sensors 124 of each of the first and second sensor members 121, 122 are disposed at four positions including front, rear, top and bottom positions. The displacement sensors are so disposed as to detect the variations of the gap between the sensors and the outside surface of the target portion 104 on the rotary bearing ring with respect to the x-axis and the z-axis directions.

Specifically, the first sensor member 121 on the inboard side includes: a first front sensor 124f and a first rear sensor 124r disposed at a front and a rear position of the rotary bearing ring; and a first top sensor 124t and a first bottom sensor 124b disposed at a top and a bottom position of the rotary bearing ring. On the other hand, the second sensor member 122 on the outboard side also includes: a second front sensor 124f and a second rear sensor 124r disposed at a front and a rear position of the rotary bearing ring; and a second top sensor 124t and a second bottom sensor 124b disposed at top and a bottom position of the rotary bearing ring.

Each of these eight displacement sensors 124 (f, r, t, b) is constituted by serially connecting a pair of coil elements 127, 127 individually having an independent detection surface to the target portion 104 and closely adjoining each other in the circumferential direction. The pair of coil elements 127, 127 are constituted by winding coil about a pair of magnetic poles 128 projecting from an inside surface of the sensor ring 123. These magnetic poles 128 project radially inwardly from the sensor ring 123 so that radial-inboard end faces thereof (detection surfaces) confront the outside surface of the target portion 104 via a radial gap therebetween.

According to the bearing assembly 100 of the embodiment, the first and second sensor members 121, 122, axially spaced from each other, are integrally mounted to the case member 115 to constitute a sensor unit, each sensor member including the four displacement sensors 124 disposed at the front, rear, top and bottom positions. Therefore, when the bearing assembly 100 is assembled, all the displacement sensors 124 can be mounted to the outer ring 101 simply by mounting the case member 115 to the inboard end of the outer ring 101. This negates the need for discretely mounting each of the displacement sensors 124 to the outer ring 101. What is more, the outer ring 101 need not be formed with through-holes for mounting the sensors.

The individual displacement sensors 124 can be circumferentially and radially positioned relative to the target portion 104 on the rotary bearing ring by mounting the case member 115 to the outer ring 101. Therefore, each of the displacement sensors 124 need not be mounted as making positional adjustment. This leads to quite an easy assembly work of the bearing assembly 100.

The displacement sensors 124 incorporated in the case member 115 have an advantage of detecting the gap with increased accuracies because the sensors detect the gap varying in conjunction with the deformation behavior of the target portion 104 located at the inboard end of the rotary bearing ring, which exhibits a greater deformation behavior under external force than that of an axially central portion (portion near the center of the bearing O shown in FIG. 9) of the rotary bearing ring.

In a case where the case member 115 equipped with the sensors is mounted to the inboard end of the outer ring 101, the displacement sensors 124 are disposed at places relatively far away from the flange 112 of the outer ring 101, so that the sensors are less affected by the strain of peripheral portions of the flange 112. This leads to an advantage that the sensors are capable of highly accurately detecting the gap variations.

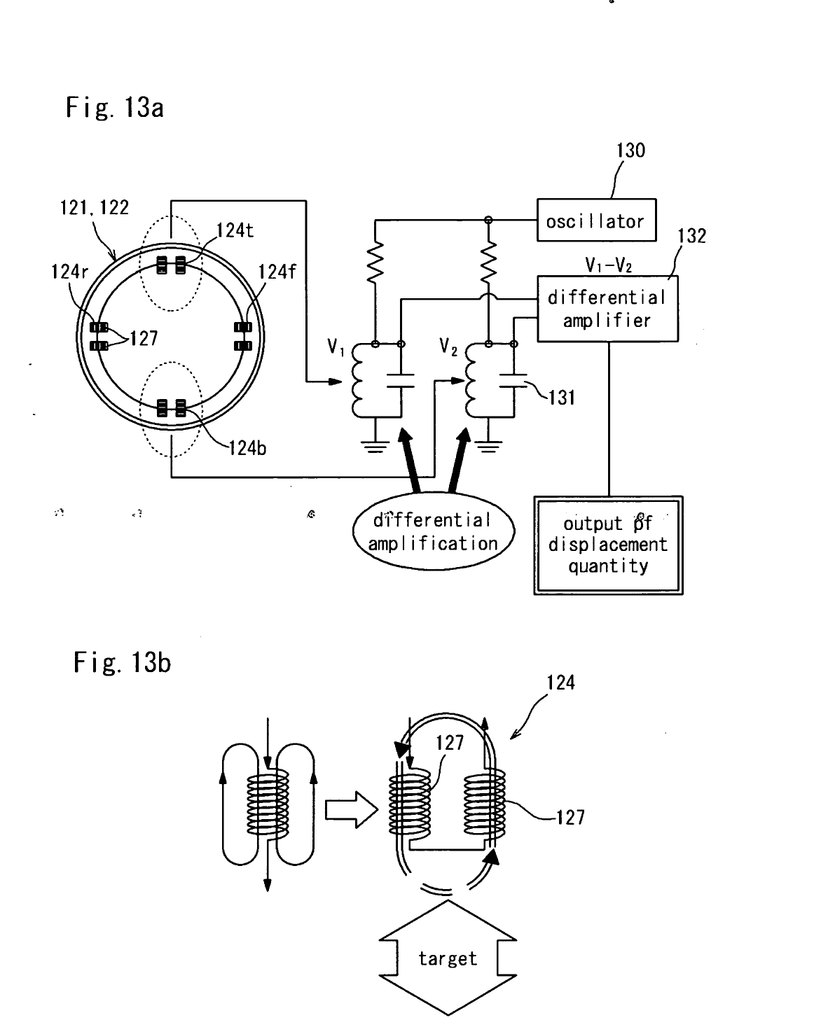

FIG. 13a illustrates an exemplary gap-detecting circuit of the sensor device 114 of the embodiment. As shown in the figure, among the displacement sensors 124 of each of the sensor members 121, 122, the sensors 124t, 124b vertically opposing each other (the top sensor and the bottom sensor in FIG. 13a and FIG. 13b) are connected to an oscillator 130, which supplies an AC current of a certain period to the individual sensors 124t, 124b. The sensors 124t, 124b are connected in parallel with respective capacitors 131 for synchronization.

The embodiment uses a differential amplifier 132 for providing an output voltage (detection value) corresponding to a quantity of vertical displacement by calculating a difference between the output voltages (detection values) from the individual sensors 124t, 124b. Thus, temperature-induced drift is eliminated from the detection value. Although not shown in the figure, the same differential amplifier as the above is also used to determine a difference between the detection values from the sensors mutually opposing in the horizontal direction, thereby eliminating the temperature-induced drift.

By the way, the following equation (a) is established in the inductance-type displacement sensor 124:
L=A×μ×N²/d (a),
where L represents the coil inductance, A represents the area of the detection surface, μ represents the magnetic permeability, N represents the number of coils, and d represents the distance (gap) between the detection surface and the target 104.

When the distance d to the target portion 104 is varied, the inductance L of the displacement sensor 124 is varied so that the output voltage is varied. Therefore, the radial gap between the detection surface of the displacement sensor 124 and the target portion 104 can be detected by detecting the variations of the output voltage.

In this embodiment, one displacement sensor 124 is constituted by serially connecting a pair of coil elements 127 each possessing the independent detection surface to the target portion 104. Hence, this displacement sensor is adapted to produce magnetic flux in higher density as compared with a case where one displacement sensor 127 is constituted by one coil element 127, as shown in FIG. 13b. Thus, the displacement sensor is further increased in detection sensitivity of the distance to the target portion 104.

As shown in FIG. 9, FIG. 10a and FIG. 10b, the target portion 104 is formed of a cylindrical member fitted about the inboard end of the inner ring member 103. The outside surface of the target portion 104 is formed with a first annular detection subject 134 confronting the detection surface (tip face of the magnetic pole 128) of the first sensor member 121 on the inboard side, and a second annular detection subject 135 confronting the detection surface of the second sensor member 122 on the outboard side. In this embodiment, these detection subjects 134, 135 are defined by a first and a second annular groove formed along the circumferential direction of the target portion 104.

As shown in FIG. 10b, the first annular groove 134 on the inboard side 134 is disposed in a manner to have its outboard groove-end face 134a located in proximity of the center of a detection surface A1 of the first sensor member 121, whereas the second annular groove 135 on the outboard side 135 is disposed in a manner to have its inboard groove-end face 135a located in proximity of the center of a detection surface A2 of the second sensor member 122.

If the target portion 104 of the rotary bearing ring is axially displaced toward the inboard side by a distance δ, for example, an axial overlap length between the first sensor member 121 and the first annular groove 134 on the inboard side is decreased so that the first sensor member 121 provides a decreased detection value of the gap. On the other hand, an axial overlap length between the second sensor member 122 and the second annular groove 135 on the outboard side is increased so that the second sensor member 122 provides an increased detection value of the gap.

Similarly, if the target portion 104 of the rotary bearing ring is axially displaced toward the outboard side by the distance δ, the first sensor member 121 on the inboard side provides an increased detection value of the gap, whereas the second sensor member 122 on the outboard side provides a decreased detection value of the gap.

Thus, the target portion 104 of the embodiment is provided with a pair of annular grooves 134, 135 on the outside surface thereof, which are axially spaced from each other so as to produce a difference between the detection values obtained by the first and second sensor members 121, 122 when the rotary bearing ring is displaced in the same sense of the axial direction.

As described above, these annular grooves 134, 135 have their axial positions relative to the sensor side defined such that the respective detection values obtained by these sensor members 121, 122 may be varied in the opposite ways (plus and minus) when the rotary bearing ring is displaced in the same sense of the axial direction.

As apparent from a calculation method taken by a control unit 137 (to be described hereinlater) for determining the detection value, a detection value for axial unit translation quantity of the rotary bearing ring is amplified by calculating the difference between the detection value from the first sensor member 121 on the inboard side and the detection value from the second sensor member 122 on the outboard side. Thus, the sensor device as a whole can be increased in the detection sensitivity of the axial displacement.

Inversely to the arrangement shown in FIG. 10b, the first annular groove 134 on the inboard side may be shifted to the outboard side relative to the detection surface A1 of the first sensor member 121, whereas the second annular groove 135 on the outboard side may be shifted to the inboard side relative to the detection surface A2 of the second sensor member 122. This arrangement may also provide the same function and effect as the above.

The respective displacement sensors 124 constituting the first and second sensor members 121, 122 are connected to the control unit 137, such as the ECU, on the vehicle side by means of a signal line 136 (see FIGS. 9 and 11) passed through the cover member 117 of the case member 115. The output voltages (detection values) obtained by the individual sensors are calculated by the control unit 137 based on the calculation method to be described hereinlater, whereby individual direction moment loads and translation loads acting on the wheel are determined.

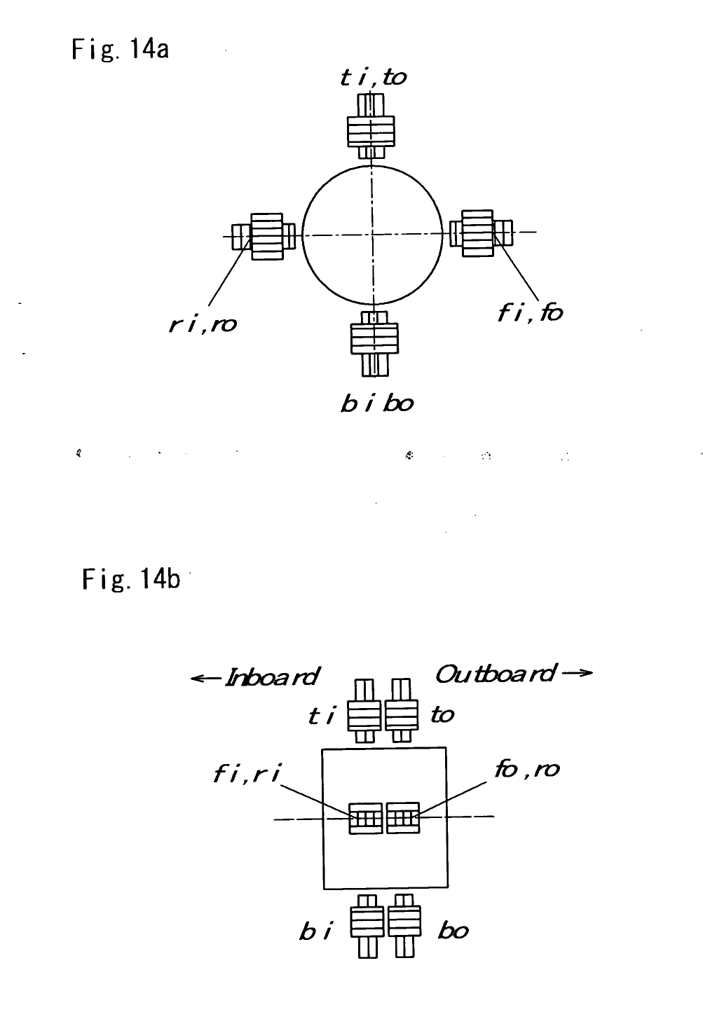

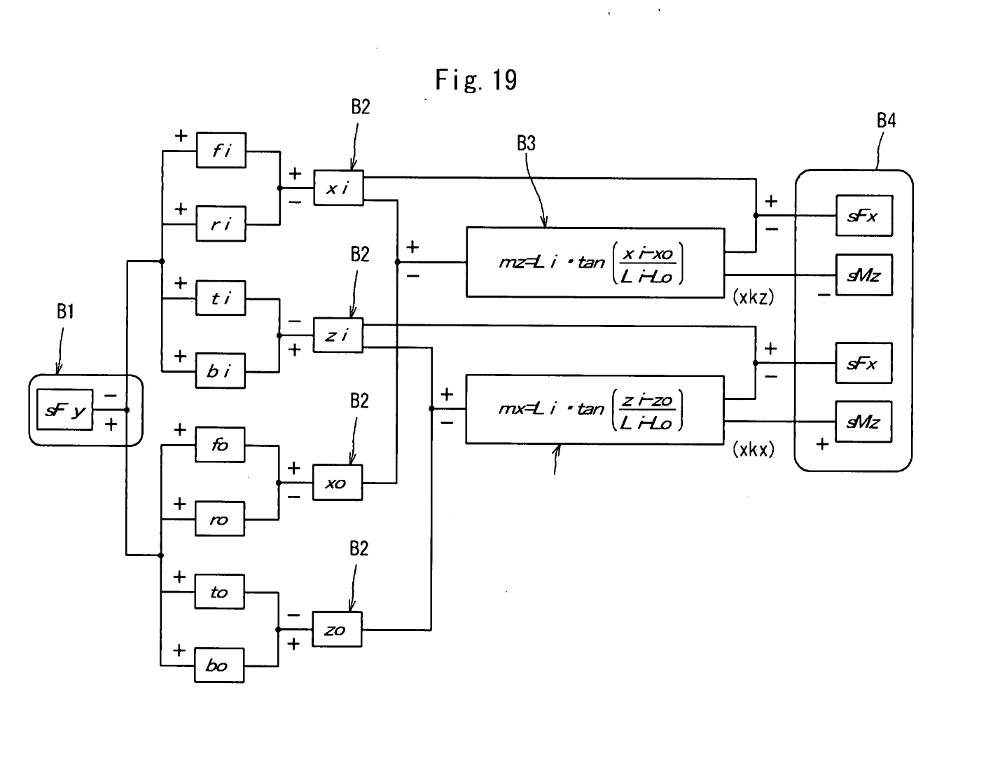

Referring to FIG. 14 to FIG. 21, the following description is made on a load calculation method taken by the control unit 137. FIG. 19 is a block diagram showing the calculation method taken by the control unit 137.

As shown in FIG. 21, a front-rear horizontal direction of the wheel is defined as the x-axis direction, a lateral horizontal direction (axial direction) of the wheel is defined as the y-axis direction, and a vertical direction of the wheel is defined as the z-axis direction.

As shown in FIG. 14a and FIG. 14b, a subscript “i” is attached to the detection value from the inboard sensor (the first sensor member 121), whereas a subscript “o” is attached to the detection value from the outboard sensor (the second sensor member 122). In addition, the detection value from the front-side sensor is defined as “f(front)”, the detection value from the rear-side sensor is defined as “r(rear)”, the detection value from the top-side sensor is defined as “t(top)”, and the detection value from the bottom-side sensor is defined as “b(bottom)”.

Accordingly, the detection values from a total number of eight sensors disposed at the first and second sensor members 121, 122 are defined as follows:
fᵢ: the detection value from the first front sensor,
rᵢ: the detection value from the first rear sensor,
tᵢ: the detection value from the first top sensor,
bᵢ: the detection value from the first bottom sensor,
fₒ: the detection value from the second front sensor,
rₒ: the detection value from the second rear sensor,
tₒ: the detection value from the second top sensor,
bₒ: the detection value from the second bottom sensor.

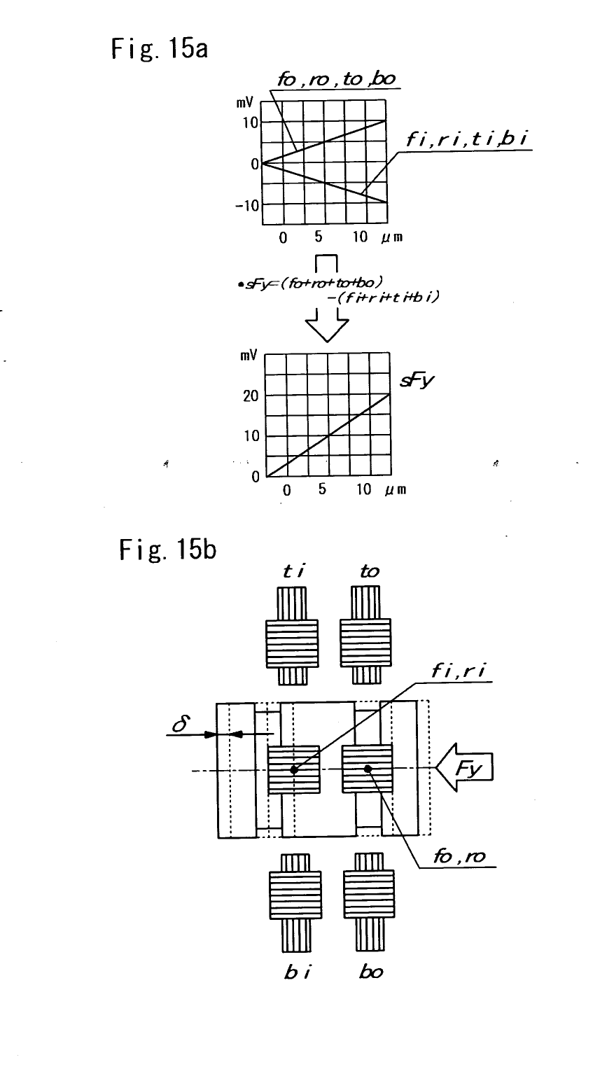

In a case where a y-axis translation load Fy is applied to the wheel, as shown in FIG. 15b, the rotary bearing ring is displaced in the direction of the load so that the annular grooves 134, 135 are shifted in the axial direction. As described above, therefore, all the detection values (output voltages in this embodiment) from the inboard sensors fᵢ, rᵢ, tᵢ, bᵢ are decreased according to the increase of the movement quantity δ in the axial direction, whereas all the detection values from the outboard sensors fₒ, rₒ, tₒ, bₒ are increased according to the increase of the movement quantity δ in the axial direction.

Therefore, sFy calculated based on the following equation (5) is adopted as an independent variable corresponding to the y-axis translation load Fy, as shown in FIG. 15b (see a calculation block B1 in FIG. 19).
sFy=(fᵢ+rᵢ+tᵢ+bᵢ)−(fₒ+rₒ+tₒ+bₒ) (5)

Thus, the value sFy corresponding to the axial unit translation quantity of the rotary bearing ring is amplified by calculating the difference between the detection values from the inboard sensor and the outboard sensor, whereby the sensor device 114 as a whole can be increased in the detection sensitivity of the axial displacement.

As shown in a calculation block B2 of FIG. 19, the detection value of the x-axis displacement is obtained by calculating a difference between the detection value f of the front sensor and the detection value r of the rear sensor, whereas the detection value of the z-axis displacement is obtained by calculating a difference between the detection value t of the top sensor and the detection value b of the bottom sensor.

Since the respective pair of front and rear sensors and of top and bottom sensors are individually affected by the temperature by the same quantity and in the same direction, temperature-induced drift can be eliminated by calculating the difference between the detection values in the aforementioned manner.

Since the embodiment locates the displacement sensors 124 on the inboard side and the outboard side, the detection value of the x-axis displacement and the detection value of the z-axis displacement can be obtained at the respective positions on the inboard side and the outboard side, as indicated by the following equations.
The detection value of the x-axis displacement on the inboard side: xᵢ=fᵢ−rᵢ
The detection value of the z-axis displacement on the inboard side: zᵢ=−tᵢ+bᵢ
The detection value of the x-axis displacement on the outboard side: x₀=fₒ−rₒ
The detection value of the z-axis displacement on the outboard side: zₒ=−tₒ+bₒ.

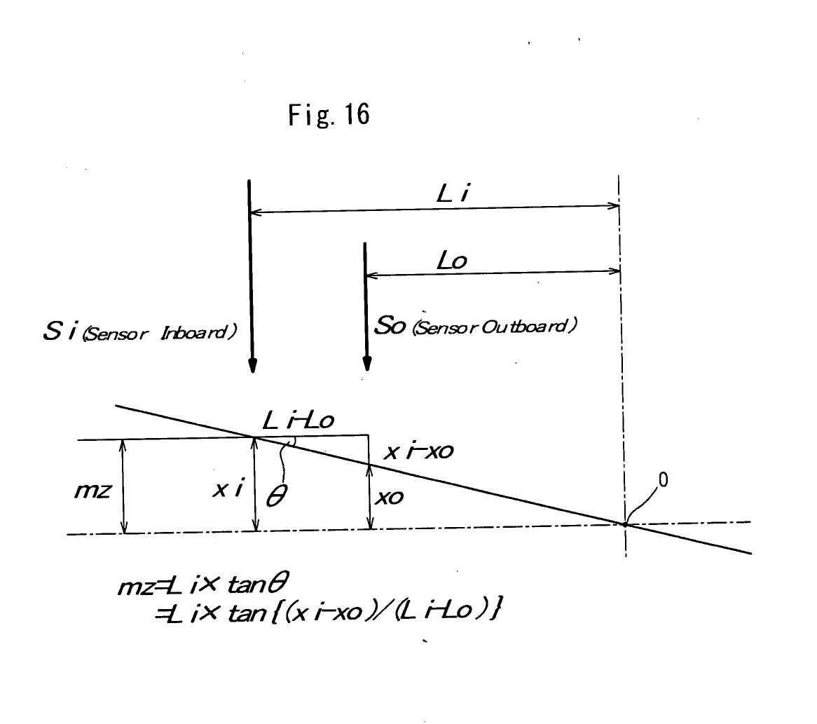

Next, a state of net moment where only a moment load Mz about the z-axis acts on the wheel is assumed as shown in FIG. 16.

The detection value corresponding to the moment load Mz about the z-axis can be theoretically defined by a value mz calculated based on the following equation, provided that Lᵢ represents an axial distance from the bearing center O to the detection position of the inboard sensor (the first sensor member 121), and that Lₒ represents an axial distance from the bearing center O to the detection position of the outboard sensor (the second sensor member 122). If θ is small enough, this value mz should agree with xᵢ.
mz=Li×tanθ=Lᵢ×tan (xᵢ−xₒ)/(Lᵢ−Lₒ)

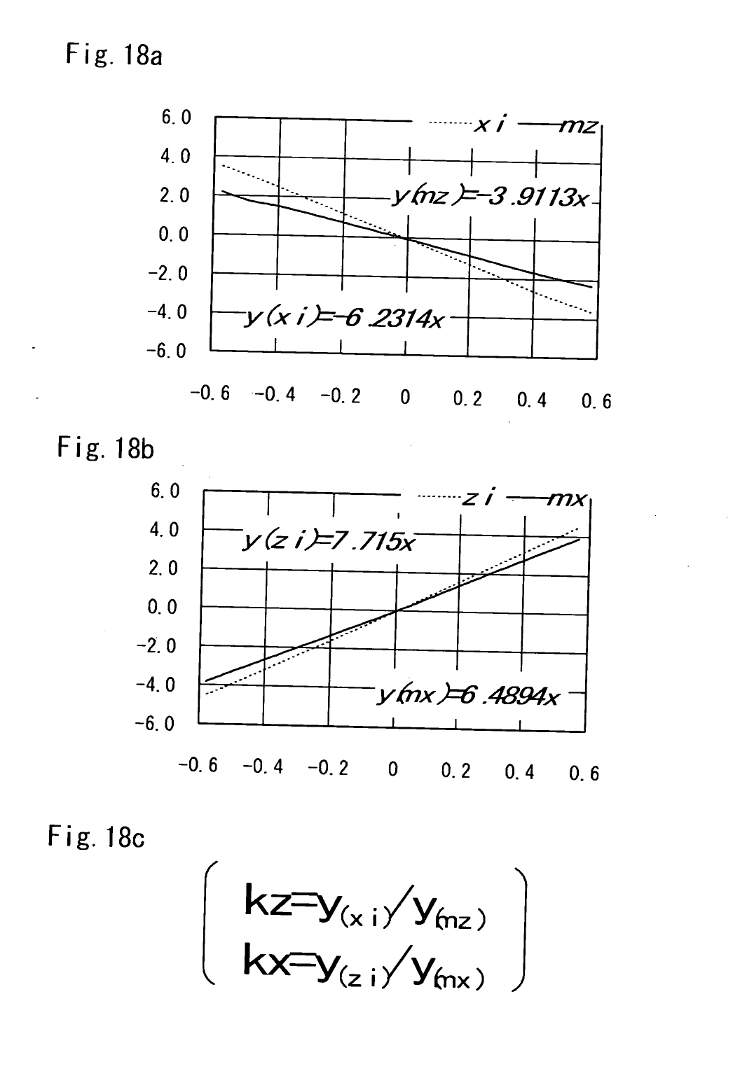

In actual fact, however, the target portion 104 is formed with the annular grooves 134, 135 and hence, the value mz does not agree with xᵢ, as indicated by FIG. 18a. FIG. 18a is a linear graph showing a relation between Mz, mz and the detection value xᵢ when only the moment load Mz about the z-axis is applied to the wheel. As indicated by the graph, the slope of the plot mz does not agree with the slope of the plot of the detection value xᵢ.

As indicated by FIG. 18c, therefore, a correction coefficient kz obtained by dividing the slope of the plot xi by the slope of the plot mz is introduced in order to establish the agreement between these slopes. As indicated by the following equation (6), an independent variable sMz corresponding to the moment load Mz about the z-axis is obtained by multiplying the above value mz by the correction coefficient kz (see calculation blocks B3 and B4 of FIG. 19). It is noted that the negative sign (−) on the right side is used for agreement with the sign of another independent variable (such as the above sFy or sMx to be described hereinlater).
sMz=−mz×kz (6)

The x-axis direction and the z-axis direction are in a relation to be brought into agreement through 90° coordinate transformation. Therefore, the independent variable sMx corresponding to the moment load Mx about the x-axis can be calculated based on the following equation (7) according to the same concept as that of the variable sMz.
sMx=mx×kx (7)

It is noted that kx in the above equation (7) is a correction coefficient introduced for the same purpose as that of the coefficient kz and is obtained by dividing the slope of the plot zᵢ by the slope of the plot mx (see FIG. 18b and FIG. 18c).

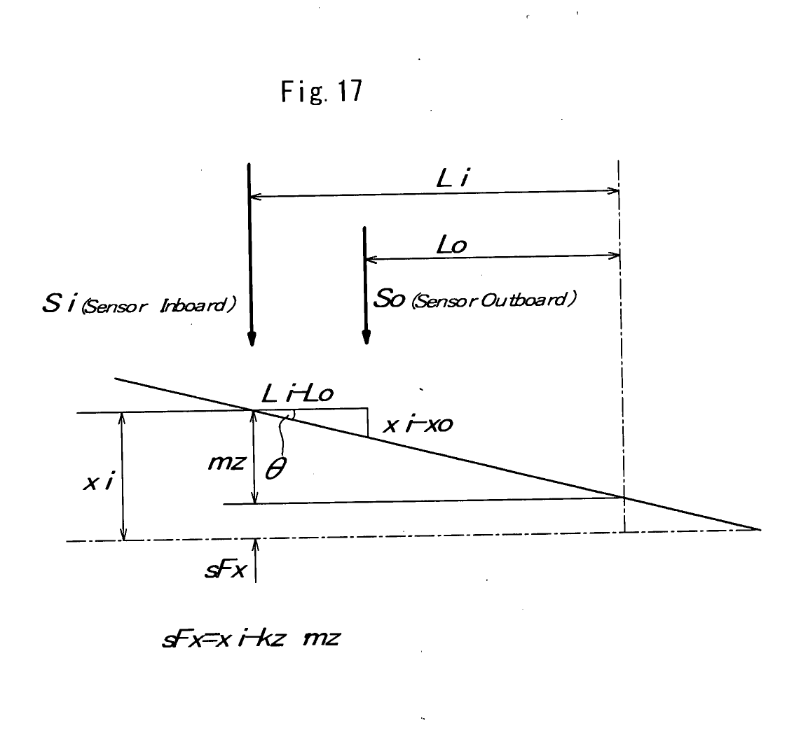

Next, a state where the moment load Mz about the z-axis along with an x-axis translation load Fx act on the wheel is assumed, as shown in FIG. 17.

In this case, the detection value xᵢ of the x-axis displacement on the inboard side contains a component of the independent variable sMz corresponding to the moment load Mz about the z-axis and a component of an independent variable sFx corresponding to the x-axis translation load Fx. Therefore, the independent variable sFx corresponding to the x-axis translation load Fx can be obtained by subtracting the value sMz from the value xᵢ.

This also holds for the case of an independent variable sFz corresponding to a z-axis translation load Fz.

Accordingly, the independent variables sFz corresponding to the z-axis translation load Fz and the independent variable sFx corresponding to the x-axis translation load Fx can be calculated using the following equations (8) and (9), respectively (see a calculation block B4 of FIG. 19).
sFz=zi−mx×kx (8)
sFx=xi−mz×kz (9)

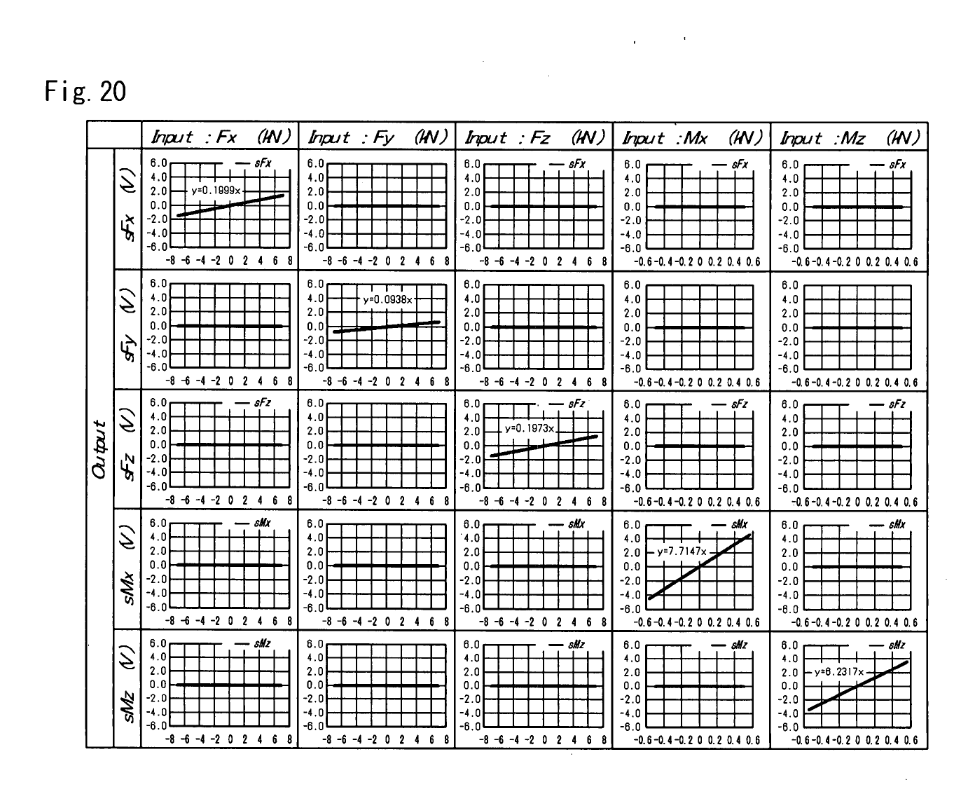

FIG. 20 shows matrix charts each showing a correlation between each independent variable sFx, sFy, sFz, sMx, sMz calculated using each of the above equations (5) to (9) and each load Fx, Fy, Fz, Mx, Mz actually applied to the wheel.

Specifically, each linear relation between each of the inputs of the loads Fx, Fy, Fz, Mx and Mz actually applied to the wheel and each of the outputs of the independent variables sFx, sFy, sFz, sMx and sMz given by the equations (5) to (9) is graphically shown in the form of matrix.

As indicated by the matrix charts of FIG. 20, only sFx exhibits the linear relation to Fx with a slope, which is not reacted by the other loads Fy, Fz, Mx and Mz. In a similar manner, only a diagonal part of the matrix chart of interest exhibits the linear relation. Accordingly, these five independent variables sFx, sFy, sFz, sMx and sMz are in linear independent relation with the five component forces Fx, Fy, Fz, Mx and Mz of the load actually applied to the wheel.

Therefore, if these independent variables sFx, sFy, sFz, sMx and sMz are determined, the individual loads Fx, Fy, Fz, Mx and Mz can be determined by solving first-degree simultaneous equations with five unknowns of the five loads Fx, Fy, Fz, Mx and Mz applied to the wheel.

In this embodiment, the aforesaid control unit 137, such as the ECU, incorporates therein an arithmetic circuit (hardware) and a control program (software) for solving the aforementioned equations (5) to (9) and the first-degree simultaneous equations with five unknowns. Therefore, the individual loads Fx, Fy, Fz, Mx and Mz actually applied to the wheel can be determined based on the eight detection values fᵢ, rᵢ, tᵢ, bᵢ, fₒ, rₒ, tₒ, bₒ obtained by the individual sensors.

It is noted that the invention is not limited to the foregoing embodiments.

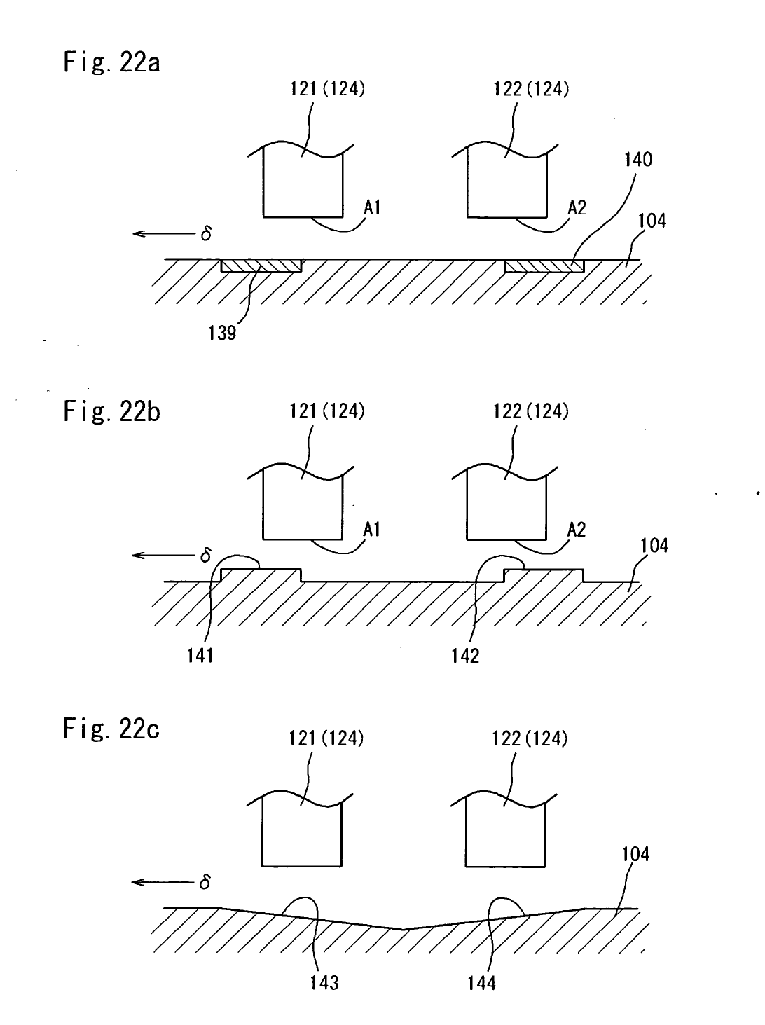

As shown in FIG. 22a, for example, annular bands 139, 140 having a greater (or smaller) magnetic permeability than that of the material constituting the peripheral portions thereof may be disposed at the annular grooves 134, 135 of the target portion 104. In a case where the peripheral portions are formed from steel, for example, such annular bands 139, 140 may be formed by varying a carbon content of the steel.

The detection subjects of the target portion 104 may be constituted by not only the aforementioned annular grooves 134, 135 but also ridges 141, 142 as shown in FIG. 22b. Furthermore, the detection subjects may also be constituted by slant surfaces 143, 144 inclined in mutually opposite directions as shown in FIG. 22c. While FIG. 22c illustrates the slant surfaces 143, 144 defining a trough at their joint, the slant surfaces may also be formed in a manner to define a ridge at their joint.

Alternatively, the sensor members 121, 122 constituting the sensor device 114 may also be mounted directly to the outer ring 101 rather than to the case member 115. While the foregoing embodiment has the arrangement wherein the outer ring 101 on the outside-circumferential side of the bearing assembly 100 constitutes the fixed bearing ring whereas the inner shaft 102 and the like on the inside-circumferential side constitute the rotary bearing ring, an alternative arrangement may also be made such that the components on the inside-circumferential side constitute the fixed bearing ring whereas the component on the outside-circumferential side constitutes the rotary bearing ring.

Furthermore, the sensor device 114 of the invention may employ not only the inductance-type displacement sensor but also any other type of non-contact displacement sensors so long as such sensors are capable of detecting the gap.

The control unit 137 performing the above calculation method and the sensor device 114 connected thereto may be applied not only to the rolling bearing assembly for vehicles but also to, for example, a magnetic bearing assembly for use in other mechanisms than the vehicles. The control unit 137 performing the calculation method shown in FIG. 19 and the axial double-row sensor device 114 prerequisite for implementing the calculation may be applied to a variety of bearing assemblies serving the needs for taking measurements of plural moment loads and translation loads.

That is, the invention may be applied to the rolling bearing assembly including the fixed bearing ring, the rotary bearing ring disposed in coaxial relation with the fixed bearing ring and rotatable relative to the fixed bearing ring, and the sensor device disposed on the fixed bearing ring for detecting the physical quantity varying in conjunction with the displacement of the peripheral surface of the rotary bearing ring. In this case, the sensor device includes the first and second sensor members individually detecting the respective physical quantities at the axially spaced positions on the peripheral surface of the rotary bearing ring. The sensor device may be connected to the control unit performing the aforementioned calculation method (for example, the calculation method shown in FIG. 20) for calculating the radial moment loads and the axial translation loads based on the detection values obtained by the individual sensor members.

What is claimed is:

1. A sensor-equipped rolling bearing assembly comprising: a cylindrical fixed bearing ring fixed to a vehicle body; a rotary bearing ring rotatably inserted through the fixed bearing ring and possessing a wheel-mounting portion on an outboard side thereof; and plural rows of rolling elements rollably interposed between these bearing rings,
wherein the bearing assembly is provided with a case member having a plurality of displacement sensors which are circumferentially arranged at predetermined space intervals and which detect gaps between themselves and an outside surface of an inboard end of the rotary bearing ring, and the case member is mounted to the inboard end of the fixed bearing ring.

2. The sensor-equipped rolling bearing assembly according to claim 1, wherein the displacement sensor is an inductance-type displacement sensor.

3. The sensor-equipped rolling bearing assembly according to claim 1 or 2, wherein the case member further has a second displacement sensor for detecting a gap between itself and an axial-end face of the inboard end of the rotary bearing ring.

4. The sensor-equipped rolling bearing assembly according to claim 1 or 2, wherein the outside surface of the inboard end of the rotary bearing ring is so configured as to produce radial and axial variations of the gap between the outside surface and the displacement sensors when a load is applied to the rotary bearing ring.

5. The sensor-equipped rolling bearing assembly according to claim 1 or 2, wherein the rotary bearing ring is formed with an annular recess in the outside surface of the inboard end thereof confronted by the plural displacement sensors.

6. The sensor-equipped rolling bearing assembly according to claim 1 or 2, wherein the rotary bearing ring is formed with an annular band on the outside surface of the inboard end thereof confronted by the plural displacement sensors, the annular band being formed from a different material from that of the rotary bearing ring.

7. The sensor-equipped rolling bearing assembly according to claim 2, wherein an annular measurement subject member, which produces a greater inductance variation in the displacement sensors than the rotary bearing ring does, is mounted to the inboard end of the rotary bearing ring, whereas the displacement sensors detect gaps between themselves and an outside surface of the measurement subject member.

8. The sensor-equipped rolling bearing assembly according to claim 1 or 2, wherein the displacement sensors are connected to an arithmetic processor for calculating the respective direction components of a load applied to the rotary bearing ring by way of calculation using respective output values from the displacement sensors and a predetermined function previously stored in the processor.

9. A sensor-equipped rolling bearing assembly comprising: a fixed bearing ring having a portion fixed to a vehicle body; a rotary bearing ring disposed coaxially with the fixed bearing ring and having a wheel-mounting portion; plural rows of rolling elements rollably interposed between these bearing rings for permitting these bearing rings to rotate relative to each other; and a sensor device disposed on the fixed bearing ring for detecting physical quantity varying in conjunction with the displacement of a peripheral surface of the rotary bearing ring,
wherein the sensor device comprises a first sensor member and a second sensor member individually detecting the respective physical quantities at axially spaced positions on the peripheral surface of the rotary bearing ring, and is connected to a control unit having an arithmetic function to calculate a moment load on the wheel based on a difference between detection values obtained by these sensor members.

10. The sensor-equipped rolling bearing assembly according to claim 9, wherein the rotary bearing ring is provided with a target portion for producing difference between the detection values from the individual sensor members when the rotary bearing ring is displaced in the same sense of an axial direction, and
wherein the sensor device is connected to the control unit also having an arithmetic function to calculate an axial translation load on the wheel based on the difference between the detection values obtained by the individual sensor members.

11. The sensor-equipped rolling bearing assembly according to claim 10, wherein the target portion includes a first annular detection subject confronting a detection surface of the first sensor member and a second annular detection subject confronting a detection surface of the second sensor member, and
wherein the detection subjects are so configured and located as to vary the detection values from the sensor members in the opposite signs of plus and minus when the rotary bearing ring is displaced in the same sense of the axial direction.

12. The sensor-equipped rolling bearing assembly according to any one of claims 9 to 11, wherein the first sensor member comprises a first front sensor and a first rear sensor disposed at a front and a rear position of the rotary bearing ring and a first top sensor and a first bottom sensor disposed at a top and a bottom position of the rotary bearing ring, and
wherein the second sensor member comprises a second front sensor and a second rear sensor disposed at a front and a rear position of the rotary bearing ring and a second top sensor and a second bottom sensor disposed at a top and a bottom position of the rotary bearing ring.

13. The sensor-equipped rolling bearing assembly according to claim 12, wherein sFy calculated based on the following equation (5) is used as an independent variable corresponding to a y-axis translation load Fy:
sFy=(fᵢ+rᵢ+tᵢ+bᵢ)−(fₒ+rₒ+tₒ+bₒ) (5),
provided that x-axis: a front-rear horizontal direction of the wheel,
y-axis: a lateral horizontal direction (axial direction) of the wheel,
z-axis: a vertical direction of the wheel,
fᵢ: a detection value from the first front sensor,
rᵢ: a detection value from the first rear sensor,
tᵢ: a detection value from the first top sensor,
bᵢ: a detection value from the first bottom sensor,
fₒ: a detection value from the second front sensor,
rₒ: a detection value from the second rear sensor,
tₒ: a detection value from the second top sensor, and
bₒ: a detection value from the second bottom sensor.

14. The sensor-equipped rolling bearing assembly according to claim 13, wherein sMz calculated based on the following equation (6) is used as an independent variable corresponding to a moment load Mz about the z-axis and sMx calculated based on the following equation (7) is used as an independent variable corresponding to a moment load Mx about the x-axis:
sMz=−mz×kz (6)
sMx=mx×kx (7),
provided that mz=Lᵢ×tan ((xᵢ−xₒ)/(Lᵢ−Lₒ)),
mx=Lᵢ×tan ((zᵢ−zₒ)/(Lᵢ−Lₒ)),
xᵢ=fᵢ−rᵢ,
zᵢ=−tᵢ+bᵢ,
xₒ=fₒ−rₒ,
zₒ=−tₒ+bₒ,
Lᵢ: an axial distance from a bearing center to the detection position of the first sensor member,
Lₒ: an axial distance from the bearing center to the detection position of the second sensor member,
kz: a correction coefficient for the independent variable sMz, and
kx: a correction coefficient for the independent variable sMx.

15. The sensor-equipped rolling bearing assembly according to claim 14, wherein sFz calculated based on the following equation (8) is used as an independent variable corresponding to a z-axis translation load Fz and sFx calculated based on the following equation (9) is used as an independent variable corresponding to an x-axis translation load Fx:
sFz=zᵢ−mx×kx (8)
sFx=xᵢ−mz×kz (9).

16. The sensor-equipped rolling bearing assembly according to any one of claims 9 to 11, wherein the individual sensor members are mounted to a single case member, whereas the case member is mounted to an inboard end of the fixed bearing ring.

17. The sensor-equipped rolling bearing assembly according to any one of claims 9 to 11, wherein each of the sensor members comprises an inductance-type displacement sensor.

18. The sensor-equipped rolling bearing assembly according to claim 17, wherein the inductance-type displacement sensor is constituted by serially connecting plural coil elements arranged circumferentially of the sensor and each having an independent detection surface.

19. The sensor-equipped rolling bearing assembly according to claim 11, wherein the detection subjects comprise annular grooves, ridges or slant surfaces formed along a circumferential direction of the target portion, the slant surfaces being inclined in mutually different directions.

20. The sensor-equipped rolling bearing assembly according to claim 11, wherein each of the detection subjects comprises an annular band formed from a material having a different magnetic permeability from that of a material constituting its peripheral portion.
